(19) United States
(12) Patent Application Publication
(10) Pub. No.: US 2009/0289970 A1
(43) Pub. Date: Nov. 26, 2009

(54) DISK RECORDING DEVICE

(75) Inventors: Takeshi MATSUI, Tokyo (JP); Tatsumi ITO, Kanagawa (JP); Shintaro TANAKA, Tokyo (JP); Yuichiro IKEMOTO, Kanagawa (JP); Koji ASHIZAKI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/429,331

(22) Filed: Apr. 24, 2009

(30) Foreign Application Priority Data
May 22, 2008 (JP) 2008-134712

(51) Int. Cl. B41J 3/00; G11B 15/52

(52) U.S. Cl. 347/2; 369/47.1

(57) ABSTRACT

A disk recording device includes a disk rotation mechanism, a pick-up device, a print head, and an air flow guide portion. The disk rotation mechanism rotates a removably mounted disk-shaped recording medium. The pick-up device is disposed such that it faces a recording surface of the disk-shaped recording medium, and it at least one of records information to and plays back information from the disk-shaped recording medium. The print head is movably disposed on a printing surface side of the disk-shaped recording medium and has an ink discharge portion that discharges ink droplets in the direction of the printing surface of the rotating disk-shaped recording medium. The air flow guide portion is provided around the disk-shaped recording medium, and it guides an air flow that is generated by the rotating of the disk-shaped recording medium by the disk rotation mechanism.

### BACKGROUND OF THE INVENTION

1. Field of the Invention

The present invention relates to a disk recording device that is capable of recording information to and playing back information from a disk-shaped recording medium, and relates in particular to a disk recording device that is capable of printing characters, images, and the like on a printing surface that is on the opposite side of the disk-shaped recording medium from a recording surface.

2. Description of the Related Art

Known disk recording devices such as optical disk devices or the like are generally widely used as devices that, after media such as optical disks or the like are transported into the interiors of the devices by loading mechanisms and are clamped (chucked) onto spindle motors, use pick-up devices such as optical heads and the like on which lenses are mounted to read information from and write information to the media. The optical disks that are used include, for example, Compact Disks (CDs), Digital Versatile Disks (DVDs), and the like that have recording capacities of several megabytes to several gigabytes.

Furthermore, optical disk media such as the Blu-ray Disk (hereinafter called the BD), the High Definition Digital Versatile Disk (HD-DVD), and the like that are capable of high-density recording have been developed recently. The BD and the HD-DVD have the same basic structure as the known media such as the CD, the DVD, and the like, but by shortening the wavelength of the light source and increasing the numerical aperture (NA) value of the lens, they achieve recording capacities that are from five times to more than ten times those of the known media such as the DVD and the like.

As the disk recording devices such as the optical disk devices and the like that use the disk-shaped recording media such as the optical disk media that can record at high density increase in number, the volume of the information that is recorded will become huge. Moreover, as the number of the disk-shaped recording media that are recorded at high density increases, it will not be easy to manage the disk-shaped recording media on which this huge volume of information is recorded.

To deal with this issue, various types of methods have been proposed for displaying on the media, such as the disks and the like, information for managing the disk-shaped recording media such as the optical disk media and the like. For example, in Japanese Patent Application Publication No. JP-A-2004-280953, a method is described for recording the information for managing the disk-shaped recording media on the recording surface of a disk in such a way that it can be visually recognized. Specifically, a method is proposed for using laser light of an optical pick-up to record in an area of the recording surface of the optical disk that is separate from an information recording area.

In addition, characters, images, and the like that correspond to the information that is recorded on the disk-shaped recording medium are printed on a label surface on the opposite side from the recording surface of the disk-shaped recording medium such as the optical disk or the like. Specifically, printing is performed on the label surface of the optical disk using an ink jet printer or the like that is capable of label printing, for example. In addition, some optical disk devices have been commercialized that incorporate ink jet print heads internally, making them capable of printing labels. An optical disk device in which a print head is mounted and that prints a label on a rotating optical disk (refer to Japanese Patent Application Publication No. JP-A-2002-512140, for example), an optical disk device that incorporates an internal printing function (refer to Japanese Patent No. 3341572, for example), and the like have been proposed as optical disk devices that are capable of printing labels in this manner.

An optical disk device that has a label printing function, such as those described in Japanese Patent Application Publication No. JP-A-2002-512140 and Japanese Patent No. 3341572, prints the characters, the images, and the like on the label surface by moving a print head parallel to the label surface (the printing surface) and discharging ink droplets from the print head in accordance with the revolution speed of the disk.

### SUMMARY OF THE INVENTION

In a case where the label printing is performed by discharging the ink droplets onto the disk-shaped recording medium such as the rotating optical disk or the like, as described above, ink droplets whose speed of discharge from the print head is slow and ink droplets that are strongly affected by air resistance (so-called satellite droplets) generate a mist. The mist creates a problem in that it floats around within the disk recording device such as the optical disk device or the like, causing the interior of the disk recording device to become contaminated. In particular, the pick-up device is more readily contaminated than in the known disk recording device, and in the case of the optical disk device, the lens portion of the optical pick-up becomes contaminated, interfering with the reading and writing (the recording and playback) of the information.

In order to inhibit this sort of internal contamination of the disk recording device, the use of a fan or the like to trap the mist has been considered. However, this gives rise to a problem in that if the fan were to malfunction and stop, the interior of the disk recording device would be contaminated, and in the worst case, the disk recording device itself would become inoperable.

Another problem is that, in some cases, the mist that floats around within the disk recording device contaminates an electrical circuit inside the device, and in that case, problems such as short circuits, improper operation, unstable operation, and the like occur.

Accordingly, the present invention addresses these problems and provides a disk recording device that, in addition to at least one of recording information to and playing back information from the recording surface of the disk-shaped recording medium, is capable of printing characters, images, and the like on the printing surface, and that also, without being provided with a special device such as a fan or the like, inhibits the contamination of the interior of the device by the mist of ink droplets that float around within the device.

According to an embodiment of the present invention, there is provided a disk recording device that includes a disk rotation mechanism, a pick-up device, a print head, and an air flow guide portion. A disk-shaped recording medium is removably mounted on the disk rotation mechanism, which rotates the mounted disk-shaped recording medium. The pick-up device is disposed such that it faces a recording surface of the disk-shaped recording medium that is mounted on the disk rotation mechanism, and it at least one of records information to and plays back information from the disk-shaped recording medium. The print head is movably disposed on a printing surface side of the disk-shaped recording medium that is mounted on the disk rotation mechanism, the printing surface being on an opposite side from the recording surface, and the print head has an ink discharge portion that discharges ink droplets in the direction of the printing surface of the rotating disk-shaped recording medium. The air flow guide portion is provided around the disk-shaped recording medium that is mounted on the disk rotation mechanism, and it guides an air flow that is generated by the rotating of the disk-shaped recording medium by the disk rotation mechanism.

This sort of configuration makes it possible for the disk recording device according to the present invention to inhibit the contamination of the interior of the device by the mist of ink droplets that float around within the device, without being provided with a special device such as a fan or the like, because the air flow guide portion guides the air flow that is generated by the rotating of the disk-shaped recording medium by the disk rotation mechanism in a specified direction (for example, to the outside of the disk recording device).

It is desirable for the air flow guide portion to be provided such that it guides the air flow that is generated by the rotating of the disk-shaped recording medium in a direction that takes it away from the pick-up device.

The disk recording device may also include a base plate that partitions an interior portion of the disk recording device into an information recording area and a printing area. The information recording area may be an area on the recording surface side of the disk-shaped recording medium that is mounted on the disk rotation mechanism, and the disk rotation mechanism and the pick-up device may be disposed in the information recording area. The printing area may be an area on the printing surface side of the disk-shaped recording medium that is mounted on the disk rotation mechanism, and the print head may be disposed in the printing area and installed on the base plate. The air flow guide portion may be at least one opening portion that is provided on the base plate.

The opening portion may also be disposed on the printing surface side of the disk-shaped recording medium that is mounted on the disk rotation mechanism.

The opening portion may also be provided in the vicinity of an outer edge portion of the disk-shaped recording medium that is mounted on the disk rotation mechanism.

The opening portion is provided downstream, in relation to the direction of the rotation of the disk-shaped recording medium, from the position of the ink discharge portion in a case where the print head is printing on the outer edge portion of the disk-shaped recording medium.

The disk recording device may also include a mist absorbing body that absorbs the mist that is carried by the air flow, the mist absorbing body being provided downstream from the air flow guide portion, in relation to the air flow that is guided by the air flow guide portion.

The disk recording device may also include a housing that encloses the disk recording device, as well as a side wall that encloses a side face of the information recording area. The mist absorbing body may be provided between the side wall and the housing.

The interior portion of the disk recording device may also be partitioned into the information recording area and the printing area. The information recording area may be an area on the recording surface side of the disk-shaped recording medium that is mounted on the disk rotation mechanism, and the disk rotation mechanism and the pick-up device may be disposed in the information recording area. The printing area may be an area on the printing surface side of the disk-shaped recording medium that is mounted on the disk rotation mechanism, and the print head may be disposed in the printing area. The disk recording device may also include the side wall that encloses the side face of the information recording area. The air flow guide portion may be at least one opening portion that is provided on the base plate.

The disk recording device may also include a disk tray that loads and unloads the disk-shaped recording medium into and out of the information recording area and has a disk carrier portion on which the disk-shaped recording medium is carried. A cutout portion may also be provided in a side face of the disk carrier portion, and the at least one opening portion may be provided in the vicinity of the cutout portion.

The disk recording device may also include the mist absorbing body that absorbs the mist that is carried by the air flow, the mist absorbing body being provided downstream from the air flow guide portion, in relation to the air flow that is guided by the air flow guide portion.

The disk recording device may also include the housing that encloses the disk recording device. The mist absorbing body may also be provided between the side wall and the housing.

The air flow guide portion may also be a rib, a portion of which is non-continuous, that is provided under the base plate in the vicinity of an outer edge portion of the disk-shaped recording medium that is mounted on the disk rotation mechanism. The disk recording device may also include the mist absorbing body that absorbs the mist that is carried by the air flow that is guided by the air flow guide portion, the mist absorbing body being provided such that it fills the non-continuous portion of the air flow guide portion.

The disk recording device may also include the disk tray that loads and unloads the disk-shaped recording medium into and out of the information recording area and has a disk carrier portion on which the disk-shaped recording medium is carried. The air flow guide portion may also be the rib, a portion of which is non-continuous, that is provided such that it surrounds an outer edge portion of the disk carrier portion. The disk recording device may also include the mist absorbing body that absorbs the mist that is carried by the air flow that is guided by the air flow guide portion, the mist absorbing body being provided such that it fills the non-continuous portion of the air flow guide portion.

The disk recording device may also include the disk tray that loads and unloads the disk-shaped recording medium into and out of the information recording area and has a disk carrier portion on which the disk-shaped recording medium is carried. The air flow guide portion may also be an opening portion that is provided in the vicinity of the outer edge portion of the disk-shaped recording medium, in a raised portion between a top face of the disk tray and the surface of the disk carrier portion on which the disk-shaped recording medium is carried.

The interior portion of the disk recording device may also be partitioned into the information recording area and the printing area. The information recording area may be an area on the recording surface side of the disk-shaped recording medium that is mounted on the disk rotation mechanism, and the disk rotation mechanism and the pick-up device may be disposed in the information recording area. The printing area may be an area on the printing surface side of the disk-shaped recording medium that is mounted on the disk rotation mechanism, and the print head may be disposed in the printing area. The disk recording device may also include the housing that encloses the disk recording device, as well as the side wall that encloses the side face of the information recording area. The air flow guide portion may also be an air flow passage, for the air flow, that is provided such that it passes through the side wall and renders the information recording area continuous with an area between the side wall and the housing.

The disk recording device may also include a barrier wall, in a portion that is disposed in a portion of the air flow passage and that prevents the air flow that rebounds after colliding with the housing from returning to the information recording area.

The disk recording device may also include the mist absorbing body that absorbs the mist that is carried by the air flow that is guided by the air flow guide portion, the mist absorbing body being provided in the area between the side wall and the housing.

A position where the air flow passage is installed may also be determined according to a speed at which the disk-shaped recording medium is rotated by the disk rotation mechanism.

According to the embodiments of the present invention, in the disk recording device that, in addition to at least one of recording information to and playing back information from the recording surface of the disk-shaped recording medium, is capable of printing characters, images, and the like on the printing surface, it is possible to inhibit the contamination of the interior of the device by the mist of ink droplets that float around within the device, without providing a special device such as a fan or the like, because the air flow that is generated by the rotation of the disk-shaped recording medium is guided in a specified direction.

### BRIEF DESCRIPTION OF THE DRAWINGS

FIG. 1 is an oblique view that shows an exterior configuration of a known (tray type) optical disk device that has a label printing function;

FIG. 2 is an oblique view that shows an exterior configuration of a known (slot type) optical disk device that has a label printing function;

FIG. 3 is an explanatory figure that shows a radial direction and a tangential direction of an optical disk;

FIG. 4 is an oblique view that shows an interior configuration of a known optical disk device;

FIG. 5 is a plan view that shows the interior configuration of the known optical disk device;

FIG. 6A is an oblique view that shows an example of a configuration of a known print head;

FIG. 6B is an oblique view that shows another example of a configuration of a known print head;

FIG. 7 is an explanatory figure that shows an example of printing in a case where the known optical disk device that has a label printing function was used;

FIG. 8 is an oblique view that shows an exterior configuration of an optical disk device according to a first embodiment of the present invention;

FIG. 9 is an oblique view that shows an interior configuration of the optical disk device according to the present embodiment;

FIG. 10 is a plan view that shows the interior configuration of the optical disk device according to the present embodiment;

FIG. 11 is an explanatory figure that shows a state in which an ink droplet is discharged from a print head according to the present embodiment;

FIG. 12 is an explanatory figure that shows a flow of a mist of ink droplets in the interior of the optical disk device according to the present embodiment;

FIG. 13 is an oblique view that shows a configuration of a label printing portion according to the present embodiment;

FIG. 14 is a plan view as seen from a bottom side of a base plate according to the present embodiment;

FIG. 15A is an explanatory figure that shows the flow of the mist during printing on an outer margin of an optical disk by the print head in the present embodiment;

FIG. 15B is an explanatory figure that shows the flow of the mist during printing on an outer margin of an optical disk by the print head in the present embodiment;

FIG. 16 is an oblique view that shows a configuration of a drive portion and the label printing portion according to the present embodiment;

FIG. 17 is an explanatory figure that shows an example of a mist absorption body according to the present embodiment;

FIG. 18 is an oblique view that shows an example in which the mist absorption body according to the present embodiment is placed on an outer side of a side wall of the drive portion;

FIG. 19 is an explanatory figure that shows another example of an air flow guide portion and the mist absorption body in the present embodiment;

FIG. 20 is an explanatory figure that shows yet another example of the air flow guide portion and the mist absorption body in the present embodiment;

FIG. 21 is an explanatory figure that shows yet another example of the air flow guide portion and the mist absorption body in the present embodiment;

FIG. 22 is an explanatory figure that shows the yet another example of the air flow guide portion and the mist absorption body in the present embodiment;

FIG. 23 is an explanatory figure that shows the flow of the mist within a drive portion of the known optical disk device as seen from a front panel side;

FIG. 24 is an explanatory figure that shows the flow of the mist within a drive portion of an optical disk device according to a second embodiment of the present invention as seen from a front panel side;

FIG. 25 is an explanatory figure that shows the flow of the mist within the drive portion of the known optical disk device as seen from a top side;

FIG. 26 is an explanatory figure that shows the flow of the mist within the drive portion of the optical disk device according to the second embodiment of the present invention as seen from a top side;

FIG. 27 is an explanatory figure that shows the flow of the mist within the drive portion of the optical disk device according to the present embodiment as seen from the top side;

FIG. 28 is an explanatory figure that shows the flow of the mist within the drive portion of the optical disk device according to a modified example of the present embodiment as seen from the top side;

FIG. 29 is an oblique view that shows an example of a configuration of an air flow passage and a barrier wall according to the present embodiment;

FIG. 30A is an explanatory figure (an oblique view) that shows a result of a simulation of drifting of mist in the known optical disk device;

FIG. 30B is an explanatory figure (a plan view) that shows the result of the simulation of the drifting of the mist in the known optical disk device;

FIG. 30C is an explanatory figure (a front view) that shows the result of the simulation of the drifting of the mist drifting in the known optical disk device;

FIG. 31A is an explanatory figure (an oblique view) that shows a result of a simulation of the drifting of the mist in the optical disk device according to the second embodiment of the present invention;

FIG. 31B is an explanatory figure (a plan view) that shows the result of the simulation of the drifting of the mist in the optical disk device according to the second embodiment of the present invention;

FIG. 31C is an explanatory figure (a front view) that shows the result of the simulation of the drifting of the mist in the optical disk device according to the second embodiment of the present invention;

FIG. 32A is an explanatory figure (an oblique view) that shows a result of a simulation of the drifting of the mist in the optical disk device according to the modified example of the second embodiment of the present invention;

FIG. 32B is an explanatory figure (a plan view) that shows the result of the simulation of the drifting of the mist in the optical disk device according to the modified example of the second embodiment of the present invention;

FIG. 32C is an explanatory figure (a front view) that shows the result of the simulation of the drifting of the mist in the optical disk device according to the modified example of the second embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Configurations and Operations of Known Disk Recording Devices

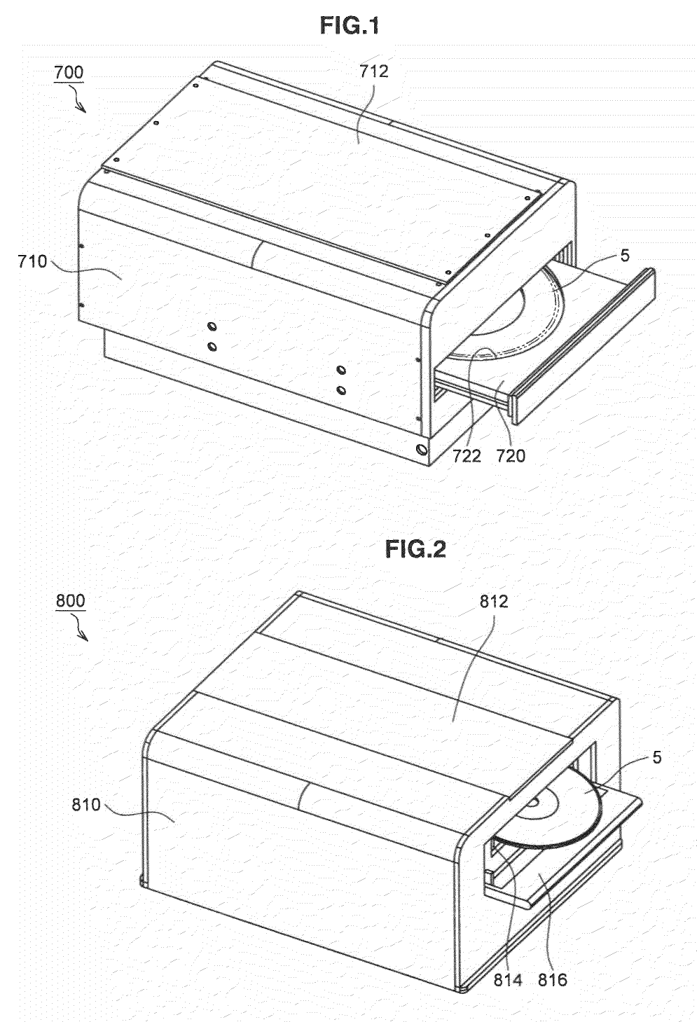

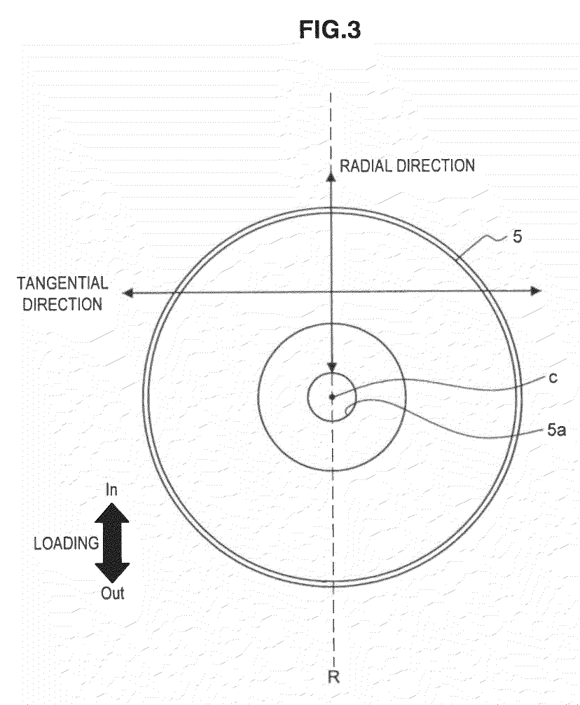

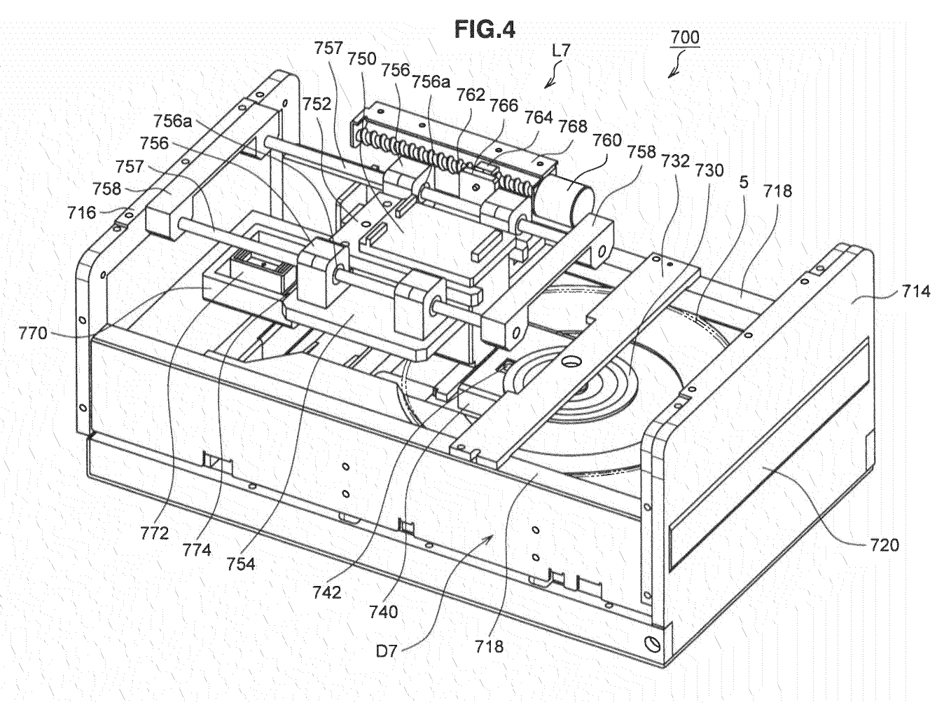

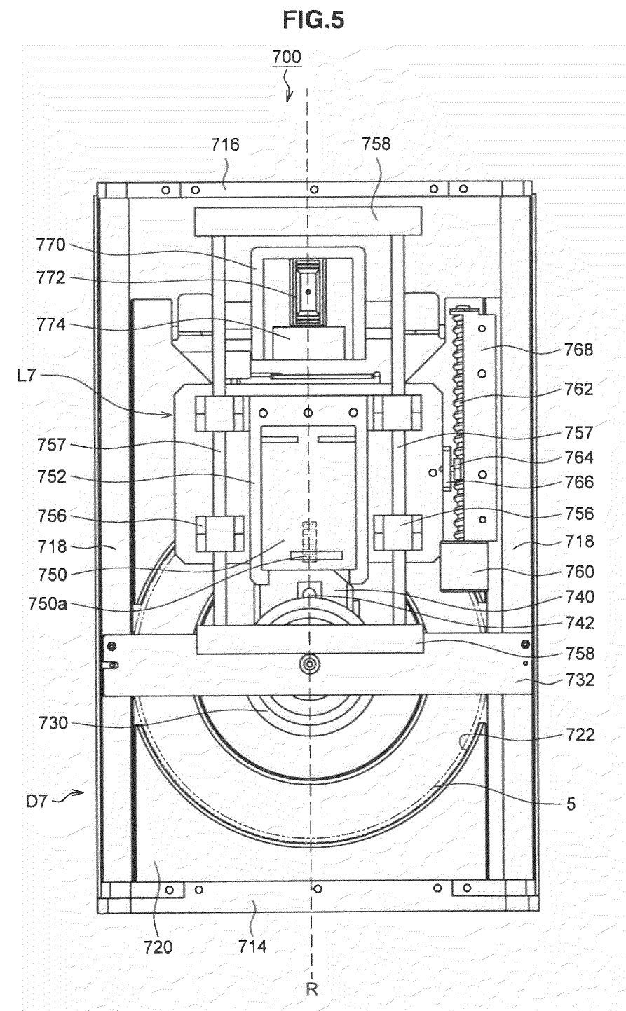

First, optical disk devices will be used as examples of known disk recording devices, and their configurations and operations will be explained based on FIGS. 1 to 5. Note that FIG. 1 is an oblique view that shows an exterior configuration of a known (tray type) optical disk device 700 that has a label printing function, and FIG. 2 is an oblique view that shows an exterior configuration of a known (slot type) optical disk device 800 that has a label printing function. FIG. 3 is an explanatory figure that shows a radial direction and a tangential direction of an optical disk 5. FIG. 4 is an oblique view that shows an interior configuration of the known optical disk device 700, and FIG. 5 is a plan view that shows the interior configuration of the known optical disk device 700.

Among the optical disk devices that are capable of recording and reading digital information using, for example, optical disk media such as Compact Disks (CDs), Digital Versatile Disks (DVDs), and the like that have recording capacities of several megabytes to several gigabytes, optical disk media such as Blu-ray Disks (BDs), High Definition Digital Versatile Disks (HD-DVDs), and the like that have recording capacities of tens of gigabytes, as well as near-field recording and the like, the optical disk device 700 and the optical disk device 800 that are shown in FIGS. 1 and 2 are examples of removable optical disk devices in which the media can be replaced. These types of optical disk devices include devices that are capable of performing label printing internally, using a disk-shaped recording medium that has an information recording surface on one face and has a label surface (a surface for printing information such as characters, images, and the like that correspond to the recorded information) on another face (a face on the opposite side from the information recording surface). Both the optical disk device 700 and the optical disk device 800 are examples of optical disk devices that are capable of label printing.

First, the exterior configurations of the optical disk device 700 and the optical disk device 800 will be explained with reference to FIGS. 1 and 2.

As shown in FIG. 1, the tray type optical disk device 700 is provided with a roughly rectangular housing 710, a top cover 712, and a tray 720. In a case where maintenance is performed, such as replacement of a print head (refer to FIGS. 4 and 5), replacement of a cap or an ink sump (refer to FIGS. 4 and 5), or the like, the top cover 712 is removed, and the maintenance is performed from above the optical disk device 700.

The tray 720 is provided such that a specified loading mechanism (not shown in the drawings) can move the tray 720 in the radial direction of the optical disk 5, moving the tray 720 from the interior to the outside of the optical disk device 700. Further, a disk carrier portion 722 that is a recessed portion with a roughly circular shape and a diameter that is roughly the same as that of the optical disk 5 is formed on the top side of the tray 720.

In this case, the radial direction means the radial direction of the roughly circular optical disk 5, as shown in FIG. 3. Further, in the present specification, a hypothetical axis that is parallel to the radial direction and passes through a center of rotation c of the optical disk 5 is called a radial axis (R). In contrast, the tangential direction means a direction that is orthogonal to the radial direction on the optical disk 5. Note that an opening portion 5a is formed in the center of the optical disk 5 that fits onto a hub portion of a spindle motor (not shown in the drawings), spindle motors being provided in the interiors of the optical disk devices 700 and 800.

The optical disk 5 is placed on the disk carrier portion 722 and is transported into the interior of the optical disk device 700 by the loading mechanism. After the optical disk 5 is thus transported into the interior of the optical disk device 700, it is clamped (chucked) onto the spindle motor (not shown in the drawings), and information that is recorded on the optical disk 5 can be read, and information can be written to the optical disk 5, by using an optical head (refer to FIGS. 4 and 5), such as an optical pick-up or the like on which a lens is mounted, to apply laser light to the information recording surface of the optical disk 5.

On the other hand, as shown in FIG. 2, the slot type optical disk device 800 is provided with a roughly rectangular housing 810, a top cover 812, an opening portion 814, and a slot cover 816. In a case where maintenance is performed, such as replacement of a print head (not shown in the drawings), replacement of a cap or an ink sump (not shown in the drawings), or the like, the top cover 812 is removed, and the maintenance is performed from above the optical disk device 800, in the same manner as in the case of the optical disk device 700.

The optical disk 5 is inserted into the opening portion 814 and is transported into the optical disk device 800 by a specified loading mechanism (not shown in the drawings). The optical disk 5 is then clamped (chucked) onto the spindle motor (not shown in the drawings), and information that is recorded on the optical disk 5 can be read, and information can be written to the optical disk 5, by using an optical head (not shown in the drawings) on which a lens is mounted to apply laser light to the information recording surface of the optical disk 5.

The opening portion 814 and the slot cover 816 are provided on a side of the housing 810 where the optical disk 5 is inserted and removed (a front side of the optical disk device 800). Furthermore, the slot cover 816 can be opened and closed, opening the opening portion 814 while the optical disk 5 is being inserted and removed and closing the opening portion 814 during the recording and playback of the optical disk 5.

Next, the interior configuration of the known optical disk device will be explained with reference to FIGS. 4 and 5, using the optical disk device 700 as an example.

As shown in FIGS. 4 and 5, the optical disk device 700 mainly includes a drive portion D7 and a label printing portion L7. The drive portion D7 performs the recording and the playback of information using the optical disk 5. The label printing portion L7 performs label printing and is provided on a label surface (a printing surface) side of the optical disk 5 that is on the opposite side from the information recording surface. That is, the label printing portion L7 is provided on a top portion of the drive portion D7.

The drive portion D7 is located within an area that is enclosed by a front panel 714, a rear panel 716, and two side panels 718, 718 that configure the housing 710, as well as by the top cover 712 (refer to FIG. 1). The drive portion D7 mainly includes the tray 720, a chucking plate 730, and an optical pick-up 740. The tray 720 is provided such that it can be moved by the specified loading mechanism. The chucking plate 730 is provided above a central portion of the disk carrier portion 722 of the tray 720. The optical pick-up 740 is provided below the tray 720 (on the information recording surface side of the optical disk 5) and serves as a pick-up device.

The tray 720 holds the optical disk 5 in the disk carrier portion 722 that is the roughly circular recessed portion that is provided on the top side of the tray 720, inserts the optical disk 5 into the interior of the optical disk device 700 and unloads it to the outside. The tray 720 is provided such that it can be moved forward and back parallel to the radial direction of the optical disk 5, and it unloads the optical disk 5 to the outside from the front side (the side of the front panel 714) of the optical disk device 700.

The chucking plate 730 is a member that has a shaft in its center portion, is attached through a bearing (not shown in the drawings) to a roughly rectangular plate-shaped chucking plate support member 732, and is supported from above by the chucking plate support member 732. The chucking plate 730 holds the optical disk 5 between itself and the hub portion of the spindle motor (not shown in the drawings) that is provided on a bottom side (the side of the information recording surface) of the optical disk 5 and rotates the optical disk 5, and the chucking plate 730 rotates together with the optical disk 5. Both ends in the long direction of the chucking plate support member 732 are attached to top surfaces of the side panels 718, and a central portion of the chucking plate support member 732 supports the chucking plate 730.

The optical pick-up 740 is provided such that it can be moved in the radial direction and is positioned below the tray 720, that is, on the recording surface side of the optical disk 5. The optical pick-up 740 also has a lens 742 for applying the laser light to the recording surface of the optical disk 5. The lens 742 can perform the recording and the playback of the information by focusing the laser light and applying the laser light to the recording surface of the optical disk 5.

In the drive portion D7 of the optical disk device 700 that has the configuration described above, the optical disk 5 is placed on the disk carrier portion 722 of the tray 720, the tray 720 moves into the interior of the device, and after the optical disk 5 is contained in the interior of the device and sandwiched between the hub portion of the spindle motor (not shown in the drawings) and the chucking plate 730, the optical disk 5 is rotated. In the state in which the optical disk 5 is rotating, the optical pick-up 740, moving in the radial direction, draws closer to the optical disk 5 to focus the laser light on the information recording surface of the optical disk 5 and performs the reading and writing of the information.

Note that other structures in the drive portion D7 are the same as in the known optical disk device, so a detailed explanation will be omitted.

The label printing portion L7 mainly includes a print head 750, a print head drive mechanism for moving the print head 750 in the radial direction, and a print head maintenance unit that performs capping and cleaning of the print head 750.

In relation to the center of the optical disk 5 (and the chucking plate 730), the print head 750 is located on the side that is opposite the front side (the front panel 714 side) of the optical disk device 700, and the print head 750 is located on the opposite side of the optical disk 5 from the optical pick-up 740 (the label surface side of the optical disk 5). The print head 750 is configured such that it can move along the radial axis R (that is, in the radial direction of the optical disk 5). An ink discharge portion 750a is provided on a bottom side of the print head 750 (the label surface side of the optical disk 5), and the label printing on the label surface of the optical disk 5 can be performed by discharging ink from the ink discharge portion 750a as the print head 750 moves along the radial axis R, facing an outer margin and an inner margin of the optical disk 5.

The print head 750 is held on three sides by a roughly C-shaped print head holder 752 and is attached to a head support plate 754. On a top side of the head support plate 754, two head drive bearing members 756 are provided on each of the left and right sides of the print head 750. In each of the head drive bearing members 756, a bearing (a linear bearing) 756a is provided such that it passes through the head drive bearing member 756 in a direction that is parallel to the radial direction. Two head drive shafts 757 are positioned roughly parallel to one another (parallel to the radial direction) such that each passes through the centers of two of the head drive bearings 756a that are aligned in the radial direction. Both of the end portions on the front panel 714 side of the two head drive shafts 757 and both of the end portions on the rear panel 716 side are respectively supported by a single shaft support member 758.

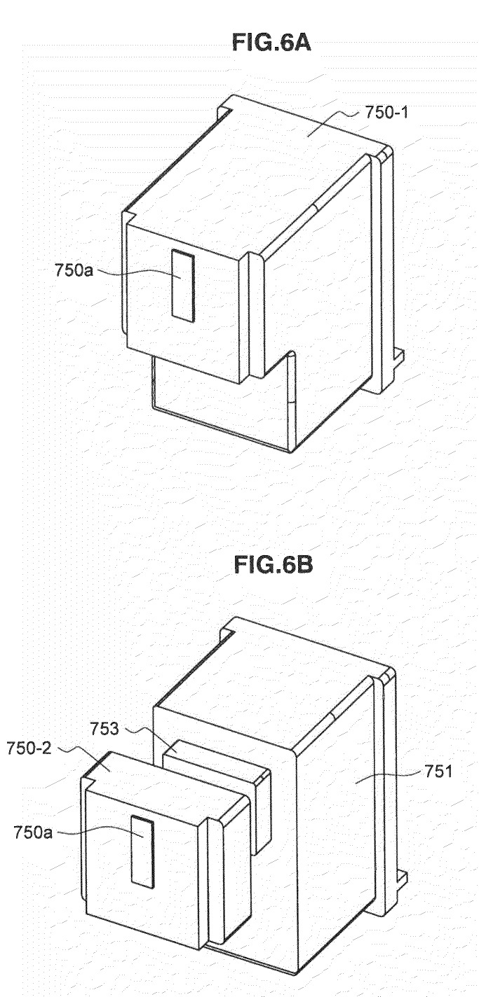

The print head 750 may be, as shown in FIG. 6A, for example, a type in which a print head 750-1 that has the ink discharge portion 750a is formed as a single unit with an ink tank portion. As shown in FIG. 6B, for example, the print head 750 may also be a type in which a print head 750-2 that has the ink discharge portion 750a is disconnectably connected to an ink tank portion 751 through a connecting portion 753. Note that in the cases of both of these types, portions that input a signal that controls the ink discharge are omitted from FIGS. 6A and 6B.

The print head drive mechanism is mainly configured from a head drive motor 760, a ball screw 762 that is joined to the head drive motor 760, a nut 764 through which the ball screw 762 passes, a connecting member 766 that connects the nut 764 and the head support plate 754, and a drive mechanism support member 768 that supports the head drive motor 760 and the ball screw 762.

The head drive motor 760 uses its motive power to rotate the ball screw 762. The ball screw 762 is provided such that it extends in a direction that is parallel to the radial direction, and the nut 764 is configured such that it can be moved in a direction that is parallel to the radial direction by the rotation of the ball screw 762. The connecting of the nut 764 and the head support plate 754 by the connecting member 766 makes it possible to move the head support plate 754 in a direction that is parallel to the radial direction in conjunction with the movement of the nut 764. The drive mechanism support member 768 supports a connecting portion between the head drive motor 760 and the ball screw 762, as well as an end portion of the ball screw 762.

Note that the shaft support members 758 and the drive mechanism support member 768 are attached to a plate-shaped support member that is provided in a top portion that is not shown in the drawings.

The print head maintenance unit is provided with a cap housing portion 770 that houses a cap 772 and an ink sump 774. The cap 772 is used to inhibit drying of the print head 750, and the ink discharge portion 750a of the print head 750 is capped by the cap 772 when printing is not being performed. The ink sump 774 is a place where dummy printing (discharging of ink from the ink discharge portion 750a that is unrelated to label printing) is done to keep air from entering the print head 750, in order to prevent printing errors that occur when the ink is not discharged because the ink discharge portion 750a is clogged, for example. The cap housing portion 770 that houses the cap 772 and the ink sump 774 is located on the rear side (the rear panel 716 side) of the optical disk device 700, on the opposite side from where the optical disk 5 is unloaded (removed).

In the label printing portion L7 of the optical disk device 700 that has the configuration described above, when the ball screw 762 is rotated by the rotation of the head drive motor 760, the nut 764 moves along the ball screw 762 in a direction that is parallel to the radial direction. Because the nut 764 is connected to the head support plate 754 through the connecting member 766, the head support plate 754 moves in the radial direction in conjunction with the movement of the nut 764. At this time, because the head drive shafts 757, through the bearings 756a, pass through the interiors of the head drive bearing members 756 that are provided on the head support plate 754, the head support plate 754 is guided by the two head drive shafts 757, which are positioned parallel to the radial direction, such that the head support plate 754 can move in a straight line in a direction that is parallel to the radial direction. The print head 750 is positioned such that its center is on the radial axis R, so the print head 750 can move freely on the radial axis R in the directions of the inner margin and the outer margin of the optical disk 5, in conjunction with the movement of the head support plate 754, that is, the movement of the nut 764.

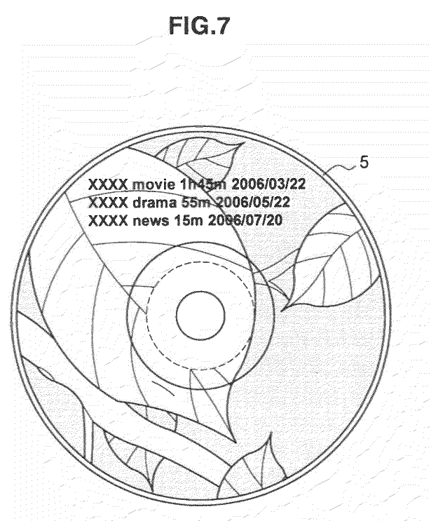

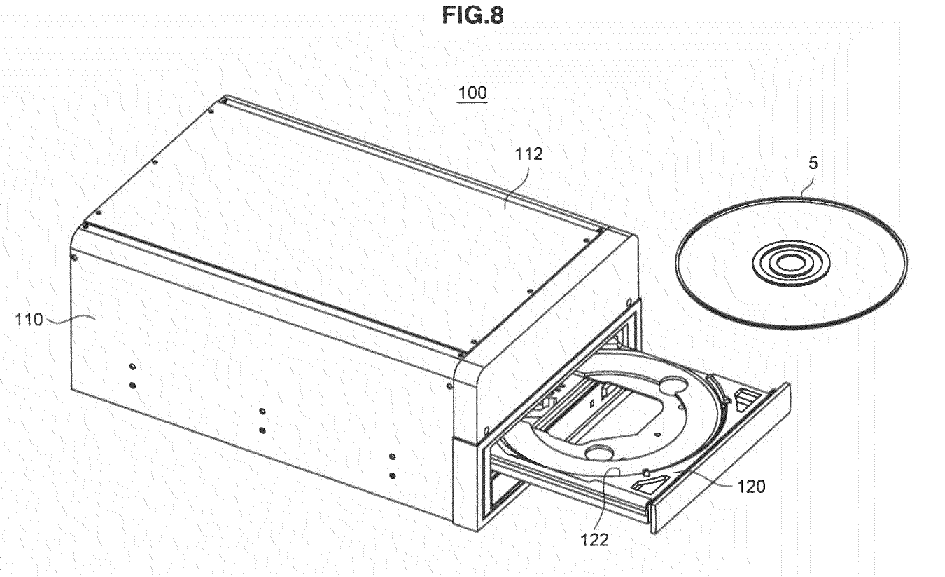

Because the label printing portion L7 has the configuration described above, a disk recording device such as the optical disk device 700 or the like can print characters, images, and the like on the label surface of a disk-shaped recording medium such as the optical disk 5 or the like, as shown by a printing example in FIG. 7.

Incidentally, the optical disk device 700 that has the label printing function like that described above prints the characters, the images, and the like on the label surface by discharging the ink droplets from the print head 750 in accordance with the revolution speed of the optical disk 5, while moving the print head 750 parallel to the label surface (the printing surface).

However, a problem occurs in that, when the characters and the like are printed on the label surface of the optical disk 5, some of the ink droplets that are discharged are dispersed within the optical disk device 700 without reaching the label surface, forming a mist that contaminates the interior of the optical disk device 700.

Locations that are contaminated include the disk carrier portion 722 of the tray 720, the optical pick-up 740 (and its cover), a bottom face of a base plate on which the label printing portion L7 is provided, an electrical circuit in the interior of the device, and the like.

A problem also occurs in that, if the mist adheres to the objective lens 742 of the pick-up device such as the optical pick-up 740 or the like, the transmissivity of the objective lens 742 that transmits the laser light diminishes, making it impossible for the optical disk device 700 to perform the processing that records and plays back the information. Still another problem is that the adherence of the mist to an electrical circuit in the interior of the optical disk device 700 causes malfunctions such as a short circuit in the electrical circuit, operating defects in the optical disk device 700, unstable operation, and the like.

Moreover, contamination of the tray 720 on which the optical disk 5 is carried creates the possibility that a user will mistakenly think that the function of the optical disk device 700 is impaired, because the tray 720 is a part that is visible to the user. In addition, if the tray 720 is contaminated by the ink mist, then lint, dust, and the like will adhere more readily to the tray 720. Therefore, when the tray 720 is inserted into the optical disk device 700, the lint, dust, and the like will be carried into the device at the same time, potentially causing malfunctions to occur in internal parts of the optical disk device 700.

Accordingly, in an optical disk device 100 according to a first embodiment of the present invention, an air flow guide portion that guides a flow of air (an air flow) that is generated by the rotation of the optical disk 5 by a disk rotation mechanism, such as a spindle motor or the like, is provided around the optical disk 5 that is mounted on the disk rotation mechanism. The air flow guide portion guides the mist of the ink droplets that float on the air flow to the outside of the device. This sort of configuration makes it possible for the optical disk device 100, without being provided with a special device such as a fan or the like, to suppress the contamination of the interior of the device by the mist of the ink droplets that float within the device, and in particular, to suppress the contamination of the optical system, such as the optical pick-up and the like, and the contamination of the electrical circuits and the like within the device.

Optical Disk Device According to the First Embodiment of the Present Invention

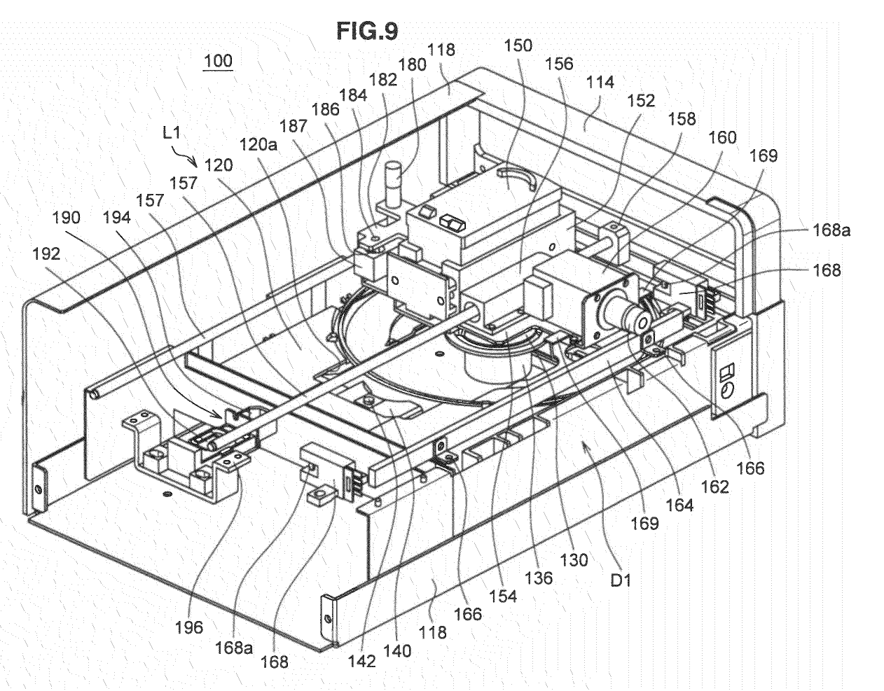

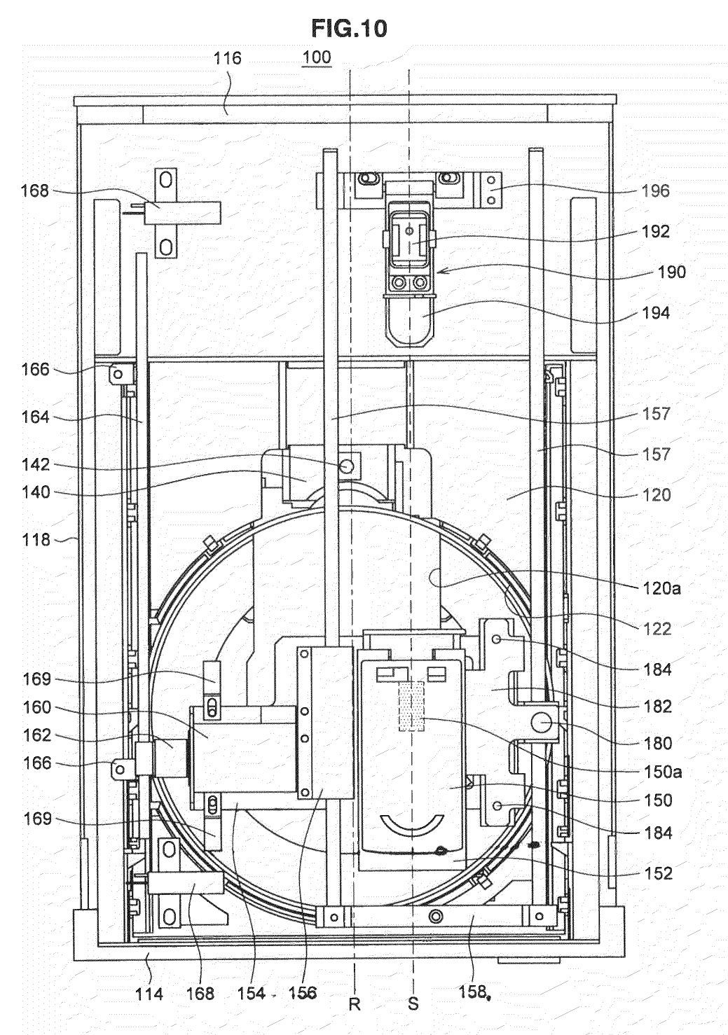

Hereinafter, a basic configuration of the optical disk device 100, as an example of an optical disk device according to the first embodiment of the present invention, will be explained with reference to FIGS. 8 to 10. Note that FIG. 8 is an oblique view that shows an exterior configuration of the optical disk device 100 according to the first embodiment of the present invention. FIGS. 9 and 10 are respectively an oblique view and a plan view that show an interior configuration of the optical disk device 100 according to the present embodiment.

The optical disk device 100 according to the present embodiment, when the optical disk 5 is inserted into it as a disk-shaped recording medium, is capable of performing the label printing on the label surface (the printing surface) of the inserted optical disk 5. The optical disk device 100 may be one of the tray type and the slot type described above, but in FIG. 8, the tray type is shown as an example.

As shown in FIG. 8 the optical disk device 100 is provided with a roughly rectangular housing 110, a top cover 112, and a tray 120. In a case where maintenance is performed, such as replacement of a print head (refer to FIGS. 9, 10, and the like), replacement of a cap or an ink sump (refer to FIGS. 9, 10, and the like), or the like, the top cover 112 is removed, and the maintenance is performed from above the optical disk device 100.

The tray 120 is provided such that a specified loading mechanism (not shown in the drawings) can move the tray 120 in the radial direction of the optical disk 5, moving the tray 120 from the interior to the outside of the optical disk device 100. Further, a disk carrier portion 122 that is a recessed portion with a roughly circular shape and a diameter that is roughly the same as that of the optical disk 5 is formed on the top side of the tray 120. Note that the definitions of the radial direction and the tangential direction are the same as for the known optical disk device, so those explanations will be omitted.

The optical disk 5 is placed on the disk carrier portion 122 and is transported into the interior of the optical disk device 100 by the loading mechanism. After the optical disk 5 is thus transported into the interior of the optical disk device 100, it is clamped (chucked) onto a spindle motor 136, and information that is recorded on the optical disk 5 can be read, and information can be written to the optical disk 5, by using an optical head (refer to FIGS. 9, 10, and the like), such as an optical pick-up or the like on which a lens is mounted, to apply laser light to the information recording surface of the optical disk 5.

As shown in FIGS. 9 and 10, the optical disk device 100 mainly includes a drive portion D1 and a label printing portion L1. The drive portion D1 performs the recording and the playback of information using the optical disk 5. The label printing portion L1 performs label printing and is provided on the label surface (the printing surface) side of the optical disk 5 that is on the opposite side from the information recording surface. That is, the label printing portion L1 is provided on a top portion of the drive portion D1. The drive portion D1 is an area on the recording surface side of the disk-shaped recording medium (for example, the optical disk 5) that is mounted on the disk rotation mechanism (for example, the spindle motor 136), and it is an example of an information recording area according to the present embodiment, in which are located the disk rotation mechanism and a pick-up device (for example, an optical pick-up 140). Further, the label printing portion L1 is an area on the printing surface side of the disk-shaped recording medium that is mounted on the disk rotation mechanism, and it is an example of a printing area according to the present embodiment, in which a print head (for example, a print head 150) is located.

Configuration of the Drive Portion D1 of the Optical Disk Device 100

The drive portion D1 is located within an area that is enclosed by a front panel 114, a rear panel 116, and two side panels 118, 118 that configure the housing 110, as well as by the top cover 112 (refer to FIG. 8). The drive portion D1 mainly includes the tray 120, a chucking plate 130, and the optical pick-up 140. The tray 120 is provided such that it can be moved by the specified loading mechanism. The chucking plate 130 is provided above a central portion of the disk carrier portion 122 of the tray 120. The optical pick-up 140 is provided below the tray 120 (on the information recording surface side of the optical disk 5) and serves as the pick-up device.

The tray 120 is provided such that the specified loading mechanism (not shown in the drawings) can move the tray 120 in the radial direction of the optical disk 5, moving the tray 120 from the interior to the outside of the optical disk device 100. Further, the disk carrier portion 122 that is a recessed portion with a roughly circular shape and a diameter that is roughly the same as that of the optical disk 5 is formed on the top side of the tray 120. In this configuration, by moving in the radial direction toward an outer margin side and an inner margin side, in a state in which the optical disk 5 is placed on the disk carrier portion 122, the tray 120 can insert the optical disk 5 into the interior of the optical disk device 100 and can unload the optical disk 5 to the outside from the front side (the side of the front panel 114) of the optical disk device 100.

The chucking plate 130 is a roughly circular disk-shaped member that has a shaft in its center portion, is attached through a bearing (not shown in the drawings) to a roughly rectangular plate-shaped chucking plate support member (not shown in the drawings), and is supported from above by the chucking plate support member. The optical disk device 100 also includes the spindle motor 136 on the bottom side (the information recording surface side) of the optical disk 5 as an example of the disk rotation mechanism according to the present embodiment. The optical disk 5 is removably mounted on a hub portion of the spindle motor 136, and the spindle motor 136 rotates the optical disk 5. When the optical disk 5 is mounted on the spindle motor 136, the chucking plate 130 holds the optical disk 5 from the label surface side of the optical disk 5. That is, the chucking plate 130 holds the optical disk 5 between itself and the hub portion of the spindle motor 136, and in this holding state, rotates together with the optical disk 5. Note that although it is not shown in the drawings, one end in the long direction of the chucking plate support member is attached to a top surface of one of the side panels 118, and another end of the chucking plate support member supports the chucking plate 130. At this time, the chucking plate support member may support the chucking plate 130 in a cantilevered state, and the other end of the chucking plate support member may be joined to one of the side panels 118 by a separate member.

The optical pick-up 140 is provided such that it can be moved in the radial direction and is positioned below the tray 120, that is, on the recording surface side of the optical disk 5 that is mounted on the spindle motor 136. The optical pick-up 140 also has a lens 142 for applying the laser light to the recording surface of the optical disk 5. The lens 142 performs the recording and the playback of the information by focusing the laser light and applying the laser light to the recording surface of the optical disk 5.

In the drive portion D1 of the optical disk device 100 that has this configuration, the optical disk 5 is placed on the disk carrier portion 122 of the tray 120, the tray 120 moves into the interior of the device, and after the optical disk 5 is contained in the interior of the device and sandwiched between the hub portion of the spindle motor 136 and the chucking plate 130, the optical disk 5 is rotated. In the state in which the optical disk 5 is rotating, the optical pick-up 140, moving in the radial direction, draws closer to the optical disk 5 to focus the laser light on the information recording surface of the optical disk 5 and performs the reading and writing of the information.

Note that other structures and operations of the drive portion D1 are the same as in the known optical disk device, so a detailed explanation will be omitted.

Configuration of the Label Printing Portion L1 of the Optical Disk Device 100

The label printing portion L1 according to the present embodiment mainly includes a print head 150, a print head drive mechanism, a distance adjustment mechanism, and a print head maintenance mechanism 190. Each of these will be explained in detail below.

The print head 150 is located on the opposite side of the optical disk 5 from the optical pick-up 140, that is, on the label surface side of the optical disk 5 that is mounted on the spindle motor 136, and it can move parallel to the radial direction. An ink discharge portion 150a is provided on a bottom side of the print head 150 (the label surface side of the optical disk 5). The label printing on the label surface of the optical disk 5 is performed by discharging ink droplets from the ink discharge portion 150a onto the label surface of the rotating optical disk 5 as the print head 150 moves in a direction that is parallel to the radial direction.

The ink discharge portion 150a may be configured from a plurality of nozzles (for example, from 300 to 400 nozzles at a pitch of approximately 40 micrometers) that are arranged in a direction that is parallel to the radial direction of the optical disk 5, for example, although the nozzles are not shown in the drawings. The nozzles that are arranged in the direction that is parallel to the radial direction may be arranged in one row and may also be arranged in a plurality of rows (for example, two rows), in which case the nozzles would be arranged two-dimensionally in a plane that is parallel to the surface of the optical disk 5.

The print head 150 according to the present embodiment, in the same manner as the known print head 750 that is shown in FIGS. 6A and 6B above, may be formed such that the print head 150 that has the ink discharge portion 150a is a single unit with an ink tank portion, and may also be formed such that the print head 150 that has the ink discharge portion 150a is disconnectably connected to an ink tank portion through a connecting portion.

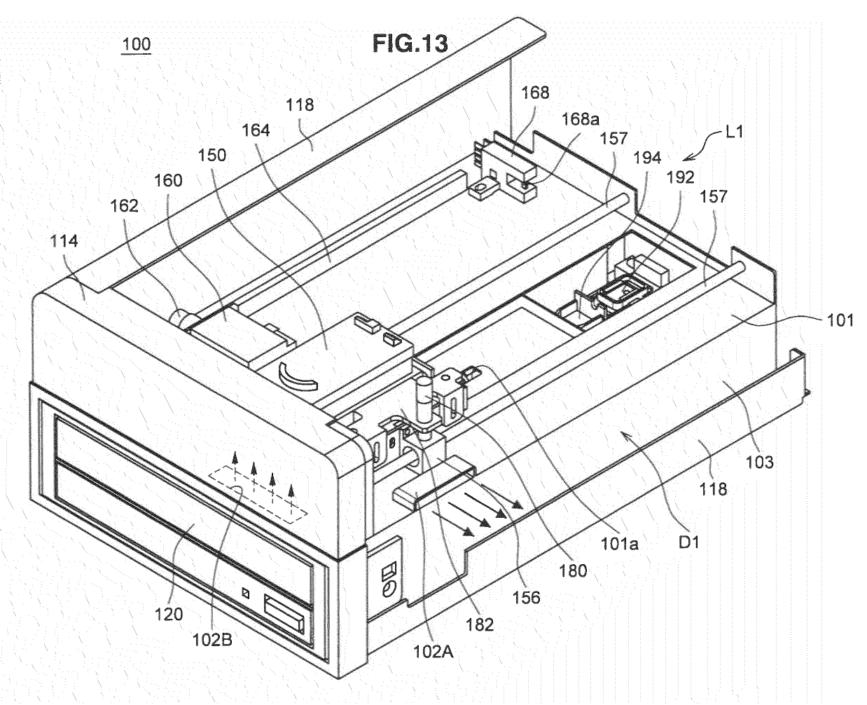

The print head 150 is also held by a head holder 152 that is arranged such that it surrounds the perimeter of the print head 150. The head holder 152 is positioned on a head support plate 154. Bearing members 156 for driving the head are provided on a top surface side of the head support plate 154, with one of the bearing members 156 on each of a left and a right side of the head holder 152. One of the bearing members 156 (the one that can be seen in FIG. 9) is attached to a side face of the head holder 152, and a bottom surface side of the bearing member 156 is attached to the head support plate 154. For the other of the bearing members 156 (refer to FIG. 13), an edge portion of the head support plate 154 is bent upward, and the bearing member 156 is attached to the bent portion. A linear bearing (not shown in the drawings) is provided for each of the bearing members 156 such that it passes through the bearing member 156 in a direction that is parallel to the radial direction. Two head drive shafts 157 are positioned roughly parallel to one another (parallel to the radial direction) such that each passes through the centers of the linear bearings that are not shown in the drawings. Both of the end portions on the front panel 114 side of the two head drive shafts 157 are supported by a shaft support member 158 that is attached to the front panel 114, and both of the end portions on the rear panel 116 side are supported by a shaft support member (not shown in the drawings) that is attached to the rear panel 116.

The print head drive mechanism according to the present embodiment moves the print head 150 parallel to the radial direction of the optical disk 5 between a printing position that is opposite the label surface of the optical disk 5 that is mounted on the spindle motor 136 and a standby position that is located away from the label surface. In concrete terms, the print head drive mechanism is mainly configured from a head drive motor 160, a pinion 162 that is provided on a motor shaft of the head drive motor 160, a rack screw 164 that guides a movement of the rotating pinion 162, and a limit sensor 168.

The head drive motor 160 uses its motive power to rotate the pinion 162. The pinion 162 is a roughly cylindrical member, and an outer circumference portion of its end portion is provided with gear teeth, although they are not shown in the drawings. The rack screw 164 is a plate-shaped member that extends in a direction that is parallel to the radial direction, and its position on a base plate 101 that will be described later (refer to FIG. 13) is fixed by rack fastening members 166. Gear teeth are also provided on a top side of the rack screw 164, and the pinion 162 and the rack screw 164 are positioned such that the gear teeth on the outer circumference portion of the end portion of the pinion 162 mesh with the gear teeth on the top of the rack screw 164. When the head drive motor 160 imparts a rotating force to the pinion 162, the pinion 162 moves parallel to the radial direction on top of the rack screw 164. Note that in the present embodiment, the gear teeth are provided on the pinion 162 and the rack screw 164, but it is not absolutely necessary to provide the gear teeth, and the pinion 162 and the rack screw 164 may also be configured such that they come into contact with a specified friction force that imparts a driving force to the pinion 162.

The limit sensor 168 controls the movement of the print head 150 in the radial direction. In concrete terms, the limit sensor 168 may be configured as a roughly C-shaped optical sensor, for example, and be provided with a light emitting element and a light receiving element (not shown in the drawings). The light emitting element and the light receiving element are provided such that they are opposite one another, and the light that is emitted from the light emitting element passes in the vertical direction through a recessed portion 168a and is received by the light receiving element. A limit sensor light shielding plate 169 is provided on a side of the head drive motor 160 on the head support plate 154.

Note that the limit sensor 168 is a member for controlling a printing area, so it is preferable for the limit sensor 168 to be installed in a position that permits the ink discharge portion 150a of the print head 150 to move at least as far as an edge portion on a rear side of the optical disk 5. Installing the limit sensor 168 in such a position makes it possible to widen a printable area when the print head 150 performs the printing on the label surface of the optical disk 5, and makes it easy to perform the printing close to the inner margin of the optical disk 5.

The ink droplets that are discharged from the ink discharge portion 150a and do not land on the label surface of the optical disk 5 form a mist and contaminate the interior of the optical disk device 100, and in the worst case, they may contaminate the optical pick-up 140. If the optical pick-up 140 is contaminated by the mist while the optical pick-up 140 is in the process of performing reading (writing) of information in relation to the optical disk 5, a possibility exists that a collision will occur between the optical disk 5 and the objective lens 142 of the optical pick-up 142. As the distance between the label surface of the optical disk 5 and the ink discharge portion 150a of the print head 150 becomes shorter, the amount of the mist that is generated diminishes, so it is desirable to shorten that distance. On the other hand, surface irregularities and the like exist in the optical disk 5, so if the distance between the label surface and the ink discharge portion 150a is too short, the ink discharge portion 150a might collide with the optical disk 5.

In light of this consideration, a distance detection portion that one of directly and indirectly measures the distance between the label surface of the optical disk 5 and the ink discharge portion 150a of the print head 150 may be provided in the optical disk device 100 according to the present embodiment, although it is not shown in the drawings. The distance detection portion can use two reflection type sensors that determine whether a specified detection point is one of near and far by emitting light from a light emitting portion onto the optical disk 5 that is the object and using a receiving portion to receive the light that is reflected. Alternatively, a sensor in a single package that can detect a distance with precision may also be used as the distance detection portion. Providing the distance detection portion makes it possible to inhibit collisions between the optical disk 5 and the print head 150 and to inhibit the ink droplets that are discharged from the print head 150 from forming a mist and contaminating the interior of the optical disk device 100.

The distance adjustment mechanism according to the present embodiment adjusts the distance between the ink discharge portion 150a and the label surface of the optical disk 5 by moving the print head 150 one of closer to and farther from the label surface, according to the distance between the ink discharge portion 150a and the label surface of the optical disk 5 that is detected by the distance detection portion described above. In concrete terms, the distance adjustment mechanism mainly includes a head raising and lowering motor 180, a flat, plate-shaped support member 182, two shafts 186 for raising and lowering the print head 150, and a bearing 187.

The support member 182 moves up and down in the vertical direction in conjunction with the rotation of the head raising and lowering motor 180 according to the present embodiment. The support member 182 is joined to the head raising and lowering motor 180 and is attached to a side face of the head holder 152. In addition, a motor shaft of the head raising and lowering motor 180 passes through the support member 182, and a bottom end portion of the motor shaft is connected to one of the bearing members 156. Bearings 184 are formed on the support member 182. Each of the shafts 186 extends in the vertical direction, and its upper end portion passes through one of the bearings 184. Two recessed portions are provided in the bearing 187, and each of the two shafts 186 is inserted into one of the two recessed portions.

The distance adjustment mechanism according to the present embodiment moves the print head 150 to a printing-capable position that is a position where the print head 150 will not touch the label surface of the optical disk 5 and where the ink droplets that are discharged from the ink discharge portion 150a can reach the label surface.

The print head maintenance mechanism 190 has a cap 192 and an ink sump 194 and is supported by a roughly U-shaped maintenance mechanism support member 196 that is fastened to the bottom of the optical disk device 100. The cap 192 is used to inhibit drying of the ink discharge portion 150a of the print head 150, and the ink discharge portion 150a of the print head 150 is capped by the cap 192 when printing is not being performed. The ink sump 194 is a place where dummy printing (discharging of ink from the ink discharge portion 150a that is unrelated to label printing) is done to keep air from entering the print head 150, in order to prevent printing errors that occur when the ink is not discharged because the ink discharge portion 150a is clogged, for example. The print head maintenance mechanism 190 that holds the cap 192 and the ink sump 194 is located on the rear side (the rear panel 116 side) of the optical disk device 100, on the opposite side from where the optical disk 5 is unloaded (removed). Note that the position where the print head maintenance mechanism 190 is provided is the position of the print head 150 when printing is not being performed.

Operation of the Label Printing Portion L1 of the Optical Disk Device 100

The configuration of the label printing portion L1 of the optical disk device 100 according to the present embodiment has been explained above. Next, the operation of the label printing portion L1 that is thus configured will be explained in detail.

(I) Operation of the Print Head 150 During Label Printing

Assume, for example, that the print head 150 is in the standby position that is located away from the label surface of the optical disk 5. Assume, that is, a state in which the ink discharge portion 150a of the print head 150 is capped by the cap 192. In this state, when the pinion 162 is rotated by the rotation of the head drive motor 160, the pinion 162 moves along the rack screw 164 toward the optical disk 5 side (the front panel 114 side) in the radial direction. The pinion 162 is coupled to the bearing members 156 through the head drive motor 160 and head support plate 154, so the bearing members 156 move toward the optical disk 5 side in the radial direction in conjunction with the movement of the pinion 162. In this case, the head drive shafts 157 pass through the interiors of the bearing members 156 through the linear bearings that are not shown in the drawings, so the bearing members 156 can be guided by the two head drive shafts 157, which are positioned roughly parallel to one another in the radial direction, such that the bearing members 156 move in a straight line in a direction that is parallel to the radial direction. Furthermore, the print head 150 is coupled to the bearing members 156 through the head holder 152 and the head support plate 154, so the print head 150 ultimately moves in a direction that is parallel to the radial direction in conjunction with the movement of the pinion 162.

The print head 150 may be located such that its center is in a position that is offset from the radial axis R. In that case, the position that is offset from the radial axis R can be moved freely toward the inner margin and the outer margin of the optical disk 5 in a direction that is parallel to the radial direction, in conjunction with the movement of the bearing members 156, that is, the movement of the pinion 162. In this sort of case, where the print head 150 is offset from the radial axis R, the print head 150 is able to move in a position where it does not interfere with the chucking plate 130 and the optical pick-up 140.

Assuming that the area that contains the optical disk 5 is divided into two areas along the line of movement of the optical pick-up 140 (that is, along the radial axis R in the present embodiment), it is preferable for the print head 150 to be located in the area that is positioned on the downstream side of the optical pick-up 140 in relation to the direction of rotation of the optical disk 5. This is because the floating ink mist that is discharged from the print head 150 is directed toward the outside of the optical disk 5 by a flow that arises in conjunction with the rotation of the optical disk 5, so if the print head 150 is located such that it is offset to the upstream side of the optical pick-up 140, the floating ink mist will tend to accumulate on the optical pick-up 140 side and contaminate the optical pick-up 140. In contrast, if the print head 150 is located such that it is offset to the downstream side of the optical pick-up 140, the ink will flow in the direction of one of the side panels 118, so if, for example, a mist absorbing body or the like were to be provided on the side panel 118, it would be easy to prevent the contamination of the optical pick-up 140 and to collect the floating ink mist.

Furthermore, as described earlier, the movement of the print head 150 in the direction that is parallel to the radial direction is controlled by the limit sensor 168 in the present embodiment. Specifically, if the print head 150 moves toward the front side of the device such that the limit sensor light shielding plate 169 is positioned at the recessed portion 168a of the limit sensor 168, the limit sensor light shielding plate 169 will block off the light that passes through the recessed portion 168a. That makes it impossible for the light receiving element of the limit sensor 168 to receive the light from the light emitting element, so the print head 150 is controlled such that it will not move any farther toward the front side of the device.

In the example described above, a case was explained in which the print head 150 always moves in a straight line in a direction that is parallel to the radial direction, but as long as the print head 150 does not interfere with the chucking plate 130 and the optical pick-up 140, it does not necessarily have to always move in a direction that is parallel to the radial direction. However, in order for the label printing on the optical disk 5 to be performed efficiently at high speed, the print head 150 may move in a direction that is parallel to the radial direction while it is moving over the optical disk 5, and may move in a direction that is not parallel to the radial direction after it moves away from the optical disk 5.

In other words, when the label printing is not being performed, maintenance such as cleaning and the like may be performed on the print head 150 in the standby position, and the ink discharge portion 150a may be capped in order to prevent drying and the like, but the standby position must be a position where the print head 150 does not interfere (does not make contact) with members that move on the radial axis R, such as the optical pick-up 140 and the like. It is therefore preferable for the standby position to be located close to the outer edge of the optical disk 5 (close to one of the side panels 118) rather than close to the center of the optical disk 5. Therefore, the print head 150 may be configured such that, when the print head 150 moves away from the optical disk 5 and moves to the standby position, the print head 150 can move in a direction that is not parallel to the radial direction in order to move farther to the outside. Note that if the ease of the label printing, the printing speed, and the like are not considered, even if the print head 150 is positioned over the optical disk 5, the print head 150 does not necessarily have to move in a straight line on an axis that is parallel to the radial axis R, as long as it moves in such a way that it does not interfere with members such as the chucking plate 130.

As explained earlier, the print head 150, when it moves over the label surface of the optical disk 5, can perform the label printing on the optical disk 5 by discharging the ink from the ink discharge portion 150a as it moves back and forth over the label surface in the radial direction.

In this manner, the label printing portion L1 according to the present embodiment can print characters, images, and the like on the label surface of a disk-shaped recording medium such as the optical disk 5, as shown by the printing example in FIG. 7.

(II) Operation of the Print Head 150 During Adjustment of the Distance From the Optical Disk 5

After the distance between the label surface of the optical disk 5 and the ink discharge portion 150a of the print head 150 is detected by the distance detection portion as described earlier, the distance adjustment mechanism performs an operation to adjust the distance between the label surface of the optical disk 5 and the print head 150 according to the detection results. The distance adjustment operation will be explained.

Assume, for example, that according to the results of the detection by the distance detection portion, the print head 150 and the optical disk 5 are in a state where they are close enough to collide. In this state, the head raising and lowering motor 180 rotates such that the support member 182 is moved upward in the vertical direction by the rotation of the head raising and lowering motor 180. In the course of this process, the shafts 186, whose upper end portions are attached to the bottom side of the support member 182 and whose lower end portions are inserted into the bearing 187, move upward together with the support member 182, such that the support member 182 moves away from the bearing 187. Because the support member 182 is attached to a side face of the head holder 152, the head holder 152 also moves upward in the vertical direction as the support member 182 moves upward, such that the print head 150 moves away from the label surface of the optical disk 5.

On the other hand, assume that according to the results of the detection by the distance detection portion, a state exists in which the print head 150 and the optical disk 5 are far enough apart that the ink droplets that are discharged from the ink discharge portion 150a form a mist instead of landing on the label surface of the optical disk 5. In this state, the head raising and lowering motor 180 rotates in the opposite direction from that explained above, such that the support member 182 is moved downward in the vertical direction by the rotation of the head raising and lowering motor 180. In the course of this process, the shafts 186, whose upper end portions are attached to the bottom side of the support member 182 and whose lower end portions are inserted into the bearing 187, move downward together with the support member 182, such that the support member 182 moves closer to the bearing 187. Because the support member 182 is attached to a side face of the head holder 152, the head holder 152 also moves downward in the vertical direction as the support member 182 moves downward, such that the print head 150 moves closer to the label surface of the optical disk 5.

Adjusting the distance between the print head 150 and the label surface of the optical disk 5 by using the distance adjustment mechanism to move the print head 150 in this manner makes it possible to prevent the print head 150 from colliding with the optical disk 5 and to prevent the ink droplets that are discharged from the ink discharge portion 150a from forming a mist and contaminating the interior of the optical disk device 100.

Flow of the Mist

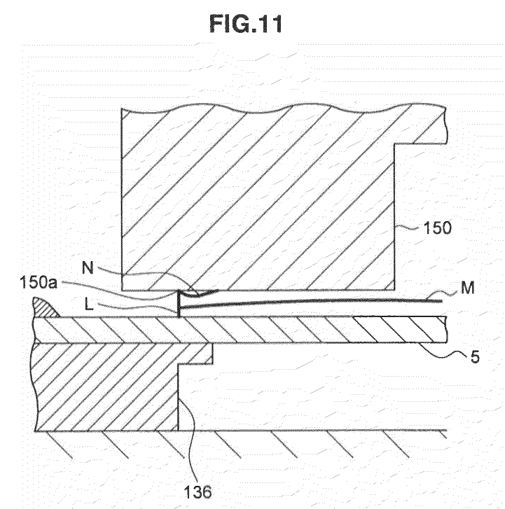

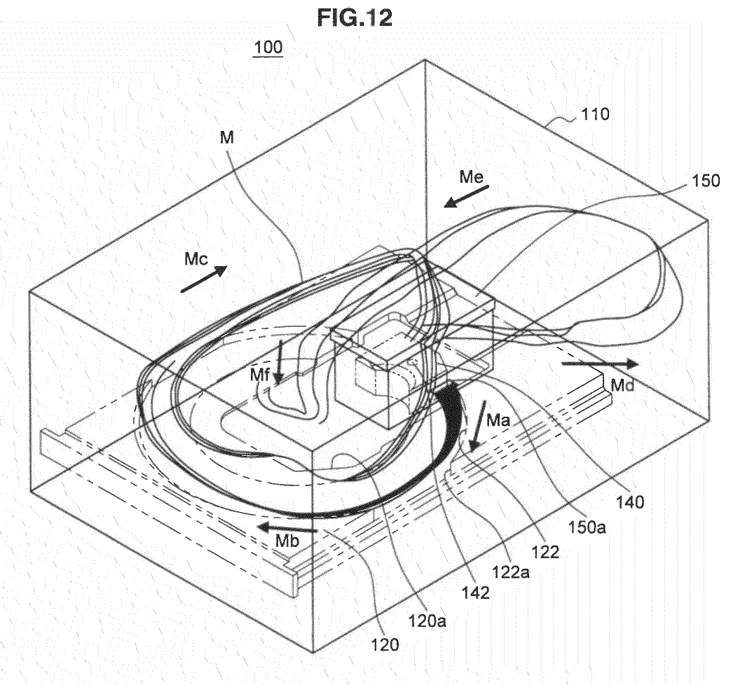

Next, the flow of the ink droplet mist in the interior of the optical disk device 100 according to the present embodiment will be explained with reference to FIGS. 11 and 12. FIG. 11 is an explanatory figure that shows a state in which an ink droplet is discharged from the print head 150 according to the present embodiment. FIG. 12 is an explanatory figure that shows the flow of the mist of the ink droplets in the interior of the optical disk device 100 according to the present embodiment.

As described earlier, ordinarily, not all of the ink droplets that are discharged from the print head 150 land on the printing surface of the optical disk 5, and in some cases, the ink droplets that do not land form a mist and float inside the device, contaminating the mechanisms, the hardware, and the like in the interior.

The printing of an image by an ink head method is performed by relative movement between the print head 150 and a printing medium (the label surface of the optical disk 5). As shown in FIG. 11, ink droplets L that have an appropriate size, such as a diameter of 10 micrometers, for example, reach the label surface of the optical disk 5 and form visible information such as a character, a diagram, or the like. On the other hand, the relative movement between the print head 150 and the printing medium causes a mist M that is formed from ink droplets that are discharged along with the ink droplets L, but have smaller diameters than the ink droplets L (for example, 5 micrometers), to float within the optical disk device 100 without landing on the label surface of the optical disk 5. Moreover, a mist N that is formed from ink droplets with even smaller diameters (for example, 1 micrometer) adheres to the print head 150 in the vicinity of the ink discharge portion 150a after being discharged from the ink discharge portion 150a.

The present embodiment uses what is called an R-theta printing method, in which the printing is performed while the optical disk 5 is rotationally driven by the spindle motor 136 of the disk rotation mechanism. When the optical disk 5 is rotated by the disk rotation mechanism at a constant speed, the rotation of the optical disk 5 generates a steady flow of air around the optical disk 5, from the center of the optical disk 5 to the outer edge in the radial direction.

Therefore, as shown in FIG. 12, when the ink droplets are discharged from the ink discharge portion 150a of the print head 150 amid the air flow that is generated when the optical disk 5 is rotationally driven, the ink droplets (the mist M) that are at least one of discharged at a slow speed and strongly affected by air resistance are carried on the flow of air (the air flow) that is generated by the rotation of the optical disk 5 and float within the optical disk device 100. Specifically, the mist M of the ink droplets that are discharged from the ink discharge portion 150a is carried on the air flow from the center of the optical disk 5 to the outer edge in the radial direction and floats toward a side face of the housing 110 and a cutout portion 122a of the disk carrier portion 122 that is the recessed portion on the tray 120, as indicated by an arrow Ma in FIG. 12. A portion of the mist M that reaches the side face of the housing 110 collides with the side face of the housing 110 and flows around to the recording surface side of the optical disk 5 and the underside of the tray 120, contaminating the optical pick-up 140 and other component parts in the interior of the device. A portion of the mist M that reaches the cutout portion 122a flows around to the recording surface side of the optical disk 5 and the underside of the tray 120 from the cutout portion 122a, contaminating the optical pick-up 140 and other component parts in the interior of the device. The remainder of the mist M is carried by the air flow from the center of the optical disk 5 to the outer edge in the radial direction and floats above the optical disk 5 along the outer edge of the optical disk 5, as indicated by an arrow Mb in FIG. 12. Then the mist M is carried by the air flow, floats toward the rear of the optical disk device 100, as indicated by an arrow Mb in FIG. 12, and becomes diffuse. A portion of the diffuse mist M floats around the outer edge of the optical disk 5, as indicated by the arrow Mb. Another portion of the diffuse mist M floats farther to the rear of the optical disk device 100, as indicated by an arrow Md, then is carried by the air flow within the device such that it floats toward the center of the optical disk 5, as indicated by an arrow Me. The mist M that reaches the center of the optical disk 5 moves downward through an opening portion 120a of the tray 120, contaminating the optical pick-up 140 and other component parts in the interior of the device.

The Air Flow Guide Portion According to the First Embodiment

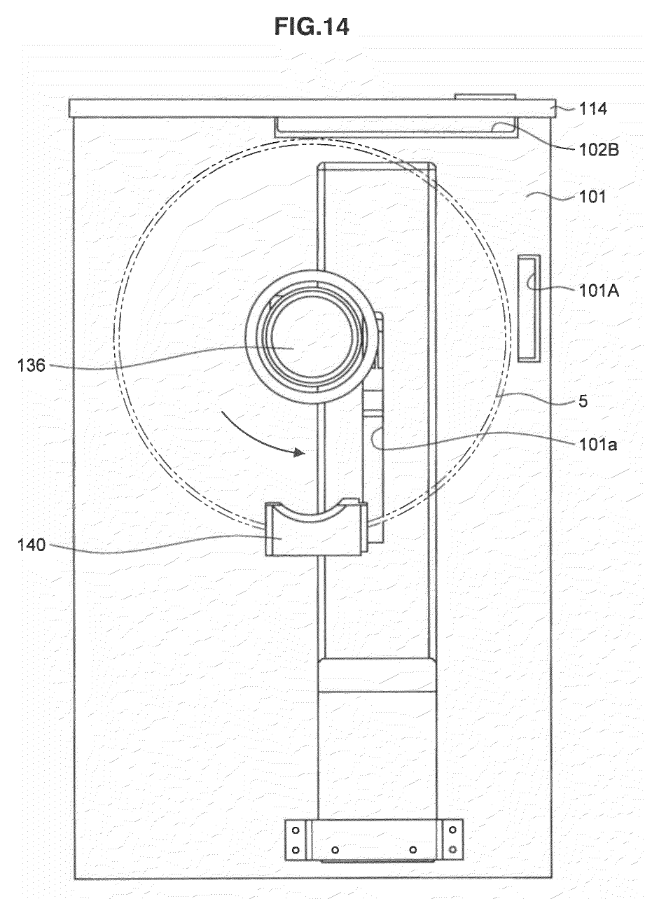

Accordingly, in the optical disk device 100 according to the present embodiment, as will be explained next, at least one opening portion is provided as the air flow guide portion according to the present embodiment in the base plate 101 that is installed in the label printing portion L1. The air flow guide portion according to the present embodiment will be explained below with reference to FIGS. 13 and 14. Note that FIG. 13 is an oblique view that shows a configuration of the label printing portion L1 according to the present embodiment. FIG. 14 is a plan view as seen from a bottom side of the base 101 plate (the recording surface side of the optical disk 5) according to the present embodiment.

As shown in FIGS. 13 and 14, in the present embodiment, the drive portion D1 is provided on a bottom plate of the optical disk device 100 and is enclosed by side walls 103 on all four sides. In addition, the drive portion D1 and the label printing portion L1 are separated by the base plate 101, and the various component parts of the label printing portion L1 (for example, the print head 150, the print head drive mechanism, the distance adjustment mechanism, a head cleaning mechanism, and the like) are provided on the base plate 101. In other words, the base plate 101 is located on the label surface side of the optical disk 5.

A slot-shaped opening portion 101a is formed in the base plate 101 to allow the ink droplets that are discharged from the print head 150 to move toward and adhere to the label surface of the optical disk 5, which is mounted below the base plate 101. The slot-shaped opening portion 101a is provided such that its longitudinal direction matches the direction of movement of the print head 150 (in the present embodiment, the direction that is parallel to the radial direction). The length of the opening portion 101a is at least roughly the same as the distance that the print head 150 moves, and the width of the opening portion 101a is at least roughly the same as the width of the print head 150. Note that from the standpoint of preventing the contamination of the drive portion D1 by the ink droplets, it is preferable for the opening portion 101a to be as small as possible.

A duct 102A and an opening portion 102B are provided in the base plate 101 as examples of opening portions that configure the air flow guide portion according to the present embodiment. The duct 102A is formed on an edge of the base plate 101 as an air passage that protrudes upward from the base plate 101, in which the bottom and one side (a side that faces one of the side panels 118) are open, but that is otherwise closed. The duct 102A thus takes the air flow that is generated below the base plate 101 by the rotation of the optical disk 5 and guides it in a horizontal direction above the base plate 101. In particular, in the present embodiment, in order to prevent the contamination of the component parts within the drive portion D1 (for example, the optical pick-up 140 and the like), the duct 102A guides the air flow above the base plate 101 to the outside in the horizontal direction (toward the side of the side panel 118). The opening portion 102B is formed as a slot-shaped opening on an edge of the base plate 101. The opening portion 102B takes the air flow that is generated below the base plate 101 by the rotation of the optical disk 5 and guides it such that it passes upward through the base plate 101 in a vertical direction. Thus the duct 102A and the opening portion 102B take the air flow that is generated by the rotation of the optical disk 5 and guide it to the outside in the horizontal direction and upward in the vertical direction in a portion that is above the drive portion D1. That is, the air flow is guided in a direction that takes it away from the drive portion D1 and the component parts in the interior of the drive portion D1 (for example, the optical pick-up 140 and the like). Therefore, in a case where the mist of the ink droplets that are discharged from the print head 150 is generated, the mist is carried by the air flow that is guided by the duct 102A and the opening portion 102B such that it tends to float in a direction that takes it away from the drive portion D1 and the component parts in the interior of the drive portion D1 (for example, the optical pick-up 140 and the like). Thus, in the optical disk device 100 according to the present embodiment, it is possible to inhibit the contamination by the mist within the drive portion D1.

Note that in the present embodiment, both the duct 102A and the opening portion 102B are provided, but it is not necessarily the case that both have to be provided, and the effect of inhibiting the contamination can be achieved as long as at least one of the duct 102A and the opening portion 102B is provided. Furthermore, there is no particular limit on the number of ducts 102A and opening portions 102B, and any number is acceptable as long as at least one is provided in a position that makes it possible to guide the air flow that is generated by the rotation of the optical disk 5 in a direction that takes it away from the drive portion D1 and the component parts in the interior of the drive portion D1 (for example, the optical pick-up 140 and the like).

As shown in FIG. 14, the duct 102A and the opening portion 102B according to the present embodiment are located close to the outer margin of the optical disk 5 that is mounted on the spindle motor 136. Locating at least one of the duct 102A and the opening portion 102B in this sort of position makes it possible for the one of the duct 102A and the opening portion 102B to efficiently draw in the air flow that is generated by the rotation of the optical disk 5 and enhances the effect of inhibiting the contamination of the drive portion D1, particularly the optical pick-up 140.

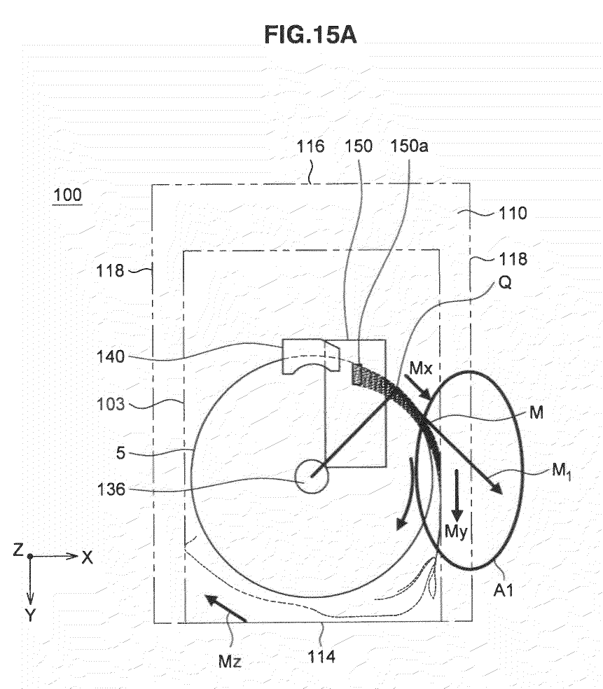

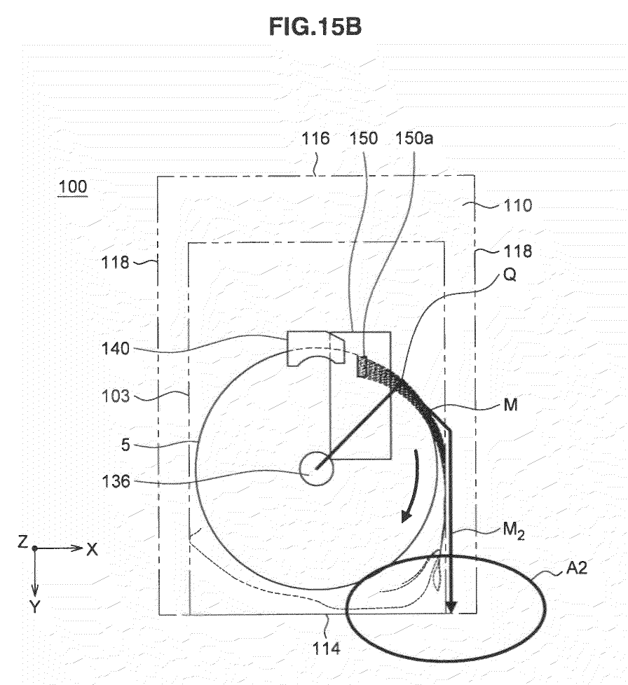

Preferred installation positions for the duct 102A and the opening portion 102B will be explained with reference to FIGS. 15A and 15B. FIGS. 15A and 15B are explanatory figures that show the flow of the mist during printing on the outer margin of the optical disk 5 by the print head 150 in the present embodiment. In FIGS. 15A and 15B, the print head 150 is provided such that it moves parallel to the radial direction on an axis (an offset axis) that is offset from the radial axis R, and an example case will be explained in which the print head 150 prints on the outer margin of the optical disk 5.

As shown in FIG. 15A, when the printing is performed by the print head 150 on the outer margin of the optical disk 5, the mist M of the ink droplets that are discharged from the ink discharge portion 150a of the print head 150, with the ink discharge portion 150a of the print head 150 serving as the source of the mist M, is carried by the flow of the air over the label surface of the optical disk 5 that is generated by the rotation, then drifts downstream in the direction of the rotation of the optical disk 5, that is, in the configuration of the present embodiment, toward one of the side walls 103 of the drive portion D1 (the side wall 103 on the side toward the print head 150) from the outer margin of the optical disk 5.

Next, the mist M reaches the outermost edge of the optical disk 5, after which it reaches an area beyond the outermost edge of the optical disk 5, where the air flow that contains the mist M collides with the side wall 103 of the drive portion D1. Having collided with the side wall 103, the mist M is carried by the flow of the air that is generated at the edge of the optical disk 5, and in the surrounding structure of the side walls 103 and the base plate 101, such that the mist M is diffused within the entire drive portion D1. At this time, after the air flow that contains the mist M reaches the area beyond the outermost edge of the optical disk 5 and collides with the side wall 103, the mist M is carried not only by the air flow that passes over the label surface of the optical disk 5, but also by an air flow that passes under the surface on the opposite side of the optical disk 5 from the label surface, that is, under the recording surface, and is diffused within the entire drive portion D1. Thus the mist M that is diffused under the recording surface of the optical disk 5 contaminates the optical pick-up 140 and other component parts.

At this time, the air flow that is generated by the rotation of the optical disk 5 reaches its maximum in the direction of the rotation and in a direction that is tangential to the optical disk 5 at a contact point Q (the direction that is indicated by an arrow M₁ in FIG. 15A), so the largest part of the mist M of the ink droplets that are discharged from the ink discharge portion 150a drifts in the direction of the tangent M₁. Therefore, the direction of the tangent M₁, that is, an area A1 that is close to the position where the mist M of the ink droplets that are discharged from the ink discharge portion 150a collides with the side wall 103, is a preferred location for providing one of the duct 102A and the opening portion 102B. Based on this viewpoint, an example is shown in FIGS. 13 and 14 described above in which the duct 102A is provided on the side of the base plate 101 toward the side panel 118 that is close to the outer edge of the optical disk 5.

In a case where the duct 102A and the opening portion 102B are not provided in the area A1, then as shown in FIG. 15B, the mist M is carried by the air flow that is generated by the rotation of the optical disk 5 and drifts along the side wall 103 toward the front of the optical disk device 100, that is, toward the front panel 114 (in the direction of an arrow M₂ in FIG. 15B). Therefore, in this case, a preferred location for providing one of the duct 102A and the opening portion 102B (refer to FIGS. 13, 14) is an area A2 on the front panel 114 side of the base plate 101 (in particular, the side to which the print head 150 is offset in a case where the print head 150 is offset from the radial axis R). Based on this viewpoint, an example is shown in FIGS. 13 and 14 described above in which the opening portion 102B is provided in the base plate 101 between the outer edge of the optical disk 5 and the front panel 114.

Note that even in a case where one of the duct 102A and the opening portion 102B is provided in the area A1, providing one of the duct 102A and the opening portion 102B in the area A2 is not a problem. In fact, it is preferable to do so, because it enhances the effect of inhibiting the contamination within the drive portion D1 by the mist M by guiding the air flow that is generated by the rotation of the optical disk 5 in a direction that takes it away from the drive portion D1 and the component parts in the interior of the drive portion D1 (for example, the optical pick-up 140 and the like).

Furthermore, in a case where the print head 150 performs the printing on the inner margin of the optical disk 5, the mist M of the ink droplets that are discharged from the ink discharge portion 150a is carried by a steady air flow that is generated in a direction that is orthogonal to a straight line that connects the position of the center of the print head 150 and the position of the ink discharge portion 150a of the print head 150, such that the mist M drifts toward the front panel 114 side of the optical disk device 100. Therefore, it is particularly preferable to provide one of the duct 102A and the opening portion 102B in the area A2.

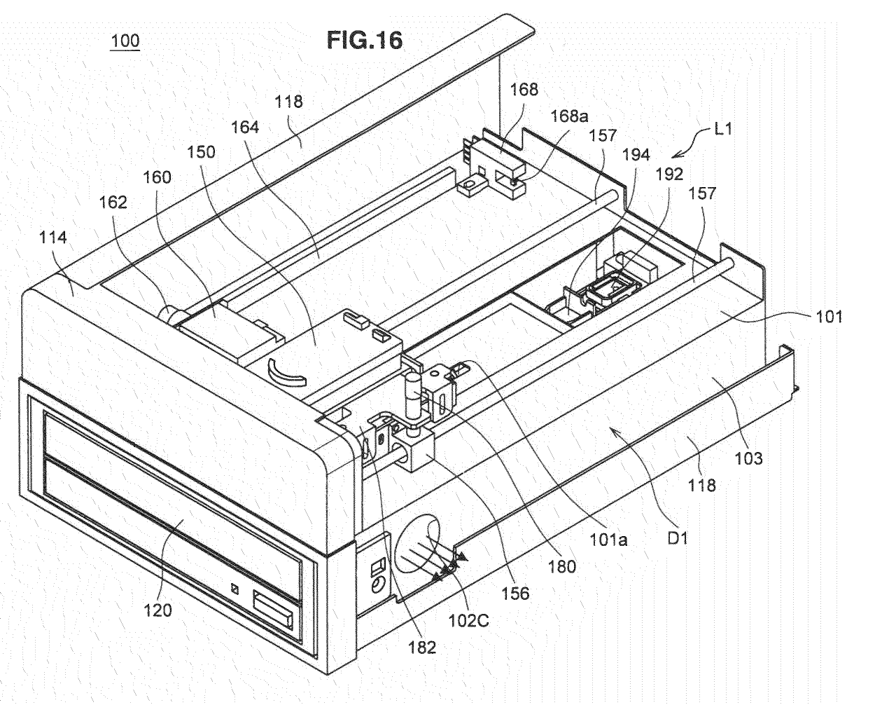

Next, another example of the air flow guide portion according to the present embodiment will be explained with reference to FIG. 16. FIG. 16 is an oblique view that shows a configuration of the drive portion D1 and the label printing portion L1 of the optical disk device 100 that uses another example of the air flow guide portion according to the present embodiment.

As shown in FIG. 16, in this example, an opening portion 102C in the side wall 103 of the drive portion D1 is provided as the air flow guide portion according to the present embodiment. The opening portion 102C is formed in the side wall 103 of the drive portion D1 as a through-hole that passes through the side wall 103. Thus the opening portion 102C takes the air flow that is generated within the drive portion D1 by the rotation of the optical disk 5 and guides it in a roughly horizontal direction through the side wall 103 to the exterior of the drive portion D1. The opening portion 102C thus guides the air flow that is generated by the rotation of the optical disk 5 directly to the outside from the drive portion D1. In other words, the air flow is guided in a direction that takes it away from the drive portion D1 and the component parts in the interior of the drive portion D1 (for example, the optical pick-up 140 and the like). Therefore, even in a case where the mist of the ink droplets that are discharged from the ink discharge portion 150a is generated, the mist is carried by the air flow that is guided by the opening portion 102C, such that the mist tends to float in a direction that takes it away from the drive portion D1 and the component parts in the interior of the drive portion D1 (for example, the optical pick-up 140 and the like). Thus, in the optical disk device 100 according to the present embodiment, it is possible to inhibit the contamination by the mist within the drive portion D1.

It is also preferable for the opening portion 102C to be provided in the vicinity of the cutout portion 122a that is positioned on the side panel 118 side of the disk carrier portion 122 of the tray 120 (refer to FIG. 12). This is because, as explained earlier, the air flow that is generated by the rotation of the optical disk 5 flows from the cutout portion 122a that is positioned on the side panel 118 side of the disk carrier portion 122 around to the underside of the optical disk 5 and the tray 120. Therefore, providing the opening portion 102C in the vicinity of the cutout portion 122a makes it possible for the opening portion 102C to efficiently draw in the air flow that is generated by the rotation of the optical disk 5 and efficiently guide the mist M that is carried by the air flow to the exterior of the drive portion D1, enhancing the effect of inhibiting the contamination of the drive portion D1, particularly the optical pick-up 140.

Note that in the example in FIG. 16, an example is shown in which the opening portion 102C is provided in the side wall 103 of the drive portion D1, but a duct (not shown in the drawings) like that shown in FIG. 13 or the like may also be provided one of instead of the opening portion 102C and together with the opening portion 102C. In that case, the duct may be provided such that it is open on a side toward the side wall 103 (the interior side of the drive portion D1) and on a top side. The duct 102A and the opening portion 102B that are described above may also be provided together with the opening portion 102C. Providing the duct 102A and the opening portion 102B together with the opening portion 102C in this manner makes it possible to enhance the effect of inhibiting the contamination of the drive portion D1, particularly the optical pick-up 140.

In the optical disk device 100 according to the present embodiment, a mist absorbing body that absorbs the mist M that is carried by the air flow may be provided in an outlet portion of the air flow guide portion, such as the duct 102A, the opening portion 102B, the opening portion 102C, or the like, that is, downstream from the air flow guide portion in the direction of the air flow that is guided by the air flow guide portion. Providing the mist absorbing body and using the mist absorbing body to absorb the mist M makes it possible to prevent the mist M that is carried by the air flow from returning to the interior of the drive portion D1 after it collides with the housing 110 (for example, the side panel 118) of the optical disk device 100, enhancing the effect of inhibiting the contamination within the drive portion D1.

A non-woven fabric or the like that is used in an air cleaner or the like can be used as a material for the mist absorbing body according to the present embodiment, as can a porous material such as a foam material (for example, a urethane sponge) or the like. The mist M contains a large amount of water, so from the standpoint of the capacity to adsorb the mist M, a hydrophilic foam material is particularly desirable as the material for the mist absorbing body. Moreover, because the mist absorbing body adsorbs (absorbs) into its interior the mist M that is carried by the air flow and blown onto the mist absorbing body, the mist absorbing body can prevent the mist M from detaching from the mist absorbing body after the mist M dries, thus preventing the mist M from once again floating within the housing 110 in a powdered form.

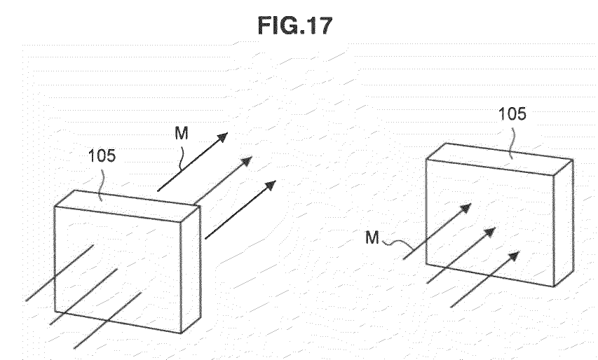

An example of the mist absorbing body is shown in FIG. 17. FIG. 17 is an explanatory figure that shows an example of a mist absorption body 105 according to the present embodiment. The mist absorbing body 105 may be, for example, a permeable type of mist absorbing body 105 that absorbs the mist M by allowing the air flow that contains the mist M to pass through it, as shown on the left side of FIG. 17. The mist absorbing body 105 may also be a bombarded type of mist absorbing body 105 that traps the mist M when it is bombarded by the air flow that contains the mist M (without letting the air flow pass through). If the permeable type of mist absorbing body 105 is used, it is desirable to use one of a non-woven fabric that is coarser than is used for the bombarded type of mist absorbing body 105 and a porous material with a lower porosity than is used for the bombarded type of mist absorbing body 105.

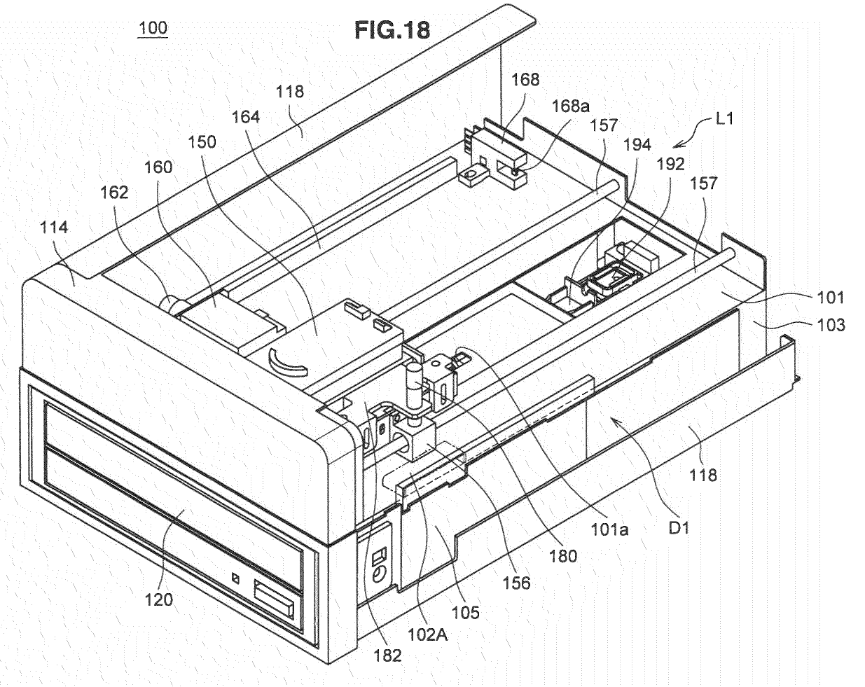

As explained above, the mist absorbing body 105 is provided downstream from the air flow guide portion in the direction of the air flow that is guided by the air flow guide portion, but more specific forms of the installation of the mist absorbing body 105 will be explained below. For example, in one case, the mist absorbing body 105 is placed close to the air flow outlet in one of the duct 102A and the opening portion 102B, causing the mist absorbing body 105 to absorb the mist M directly. In another case, the mist absorbing body 105 is placed on a surface on the outer side of the side wall 103 of the drive portion D1, causing the mist absorbing body 105 to absorb the mist M that is contained in the air flow that is guided by the duct 102A. In still another case, the mist absorbing body 105 is placed such that it covers the opening portion 102C that is provided in the side wall 103 of the drive portion D1, causing the mist absorbing body 105 to absorb the mist M directly at the opening portion 102C. Thus various forms of installation are conceivable, but of these, the example in which the mist absorbing body 105 is placed on the surface on the outer side of the side wall 103 of the drive portion D1 is shown in FIG. 18. FIG. 18 is an oblique view that shows an example in which the mist absorption body 105 according to the present embodiment is placed on an outer side of the side wall 103 of the drive portion D1.

As shown in FIG. 18, the mist absorption body 105 according to the present embodiment is located between the side wall 103 of the drive portion D1 and the side panel 118 of the housing 110 of the optical disk device 100 (in this example, on the surface of the outer side of the side wall 103). The mist absorbing body 105 is also provided such that it covers an opening portion of the duct 102A on the side that faces the side wall 103. As explained above, the air flow along the outer edge portion of the optical disk 5 that is generated by the rotation of the optical disk 5 within the drive portion D1 is guided by the duct 102A from the drive portion D1 to the outer side (the side that faces the side wall 103) of the top of the base plate 101 in the horizontal direction. At this time, the fact that the mist absorbing body 105 is provided such that it covers the opening portion of the duct 102A on the side that faces the side wall 103 means that the mist M that is carried by the air flow that moves toward the outside from the opening portion of the duct 102A on the side that faces the side wall 103 is absorbed by the mist absorbing body 105 in the vicinity of the outlet from the duct 102A.

Note that the mist absorbing body 105 may also be provided such that it covers the entire side wall 103, but as long as it is provided such that it covers at least the opening portion of the duct 102A on the side that faces the side wall 103, the mist M will be absorbed by the mist absorbing body 105, and the effect of inhibiting the contamination within the drive portion D1 can be enhanced.

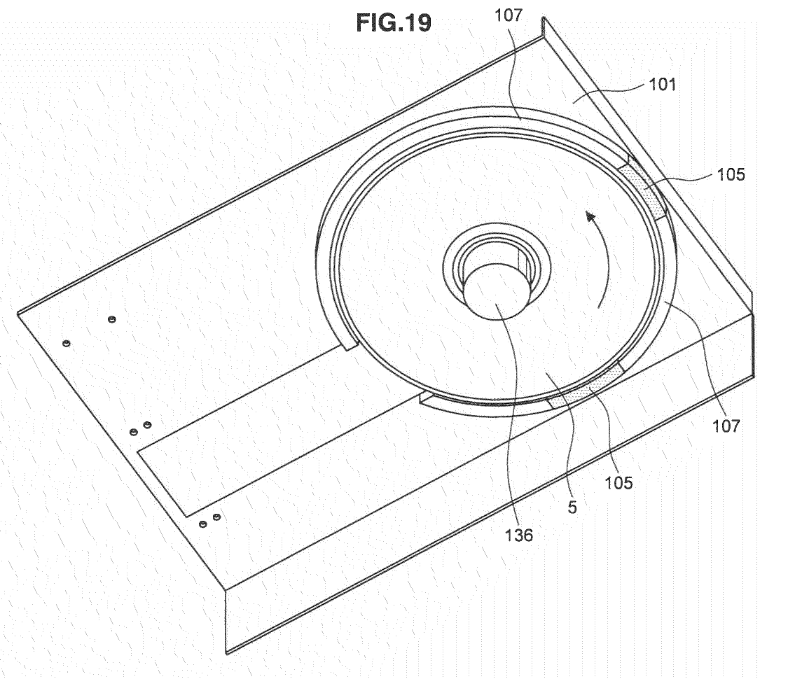

Next, another example of the air flow guide portion and the mist absorbing body according to the present embodiment will be explained with reference to FIG. 19. FIG. 19 is an explanatory figure that shows another example of the air flow guide portion and the mist absorption body in the present embodiment, and it is an oblique view that shows the bottom side of the drive portion D1 and the base plate 101 (the recording surface side of the optical disk 5).

As shown in FIG. 19, this example is an example in which ribs 107 and the mist absorbing bodies 105 are provided around the outer edge portion of the optical disk 5 on the bottom side of the label printing portion L1, and more specifically, on the bottom side of the base plate 101. In this case, the ribs 107 are examples of the air flow guide portion according to the present embodiment. In this example as well, the print head 150 is provided in a position that is offset from the radial axis R, and the mist absorbing bodies 105 are provided in a location on the side toward the side wall 103 in the direction in which the print head 150 is offset (for example, in the vicinity of the cutout portion 122a of the disk carrier portion 122) and in a location on the front side (the front panel 114 side). As explained earlier, the mist M that is carried by the air flow that is generated by the rotation of the optical disk 5 collides with the side wall 103 and flows around to the underside of the optical disk 5 and the tray 120, diffusing along the side wall 103 toward the front side (the front panel 114 side) of the optical disk device 100. Therefore, in order to guide the air flow that contains the mist M to the outside of the drive portion D1, and in particular, in a direction that takes it away from the optical pick-up 140, the ribs 107 are provided on the bottom side of the base plate 101, along the outer edge portion of the optical disk 5, and the mist absorbing bodies 105 are positioned in the location on the side toward the side wall 103 and in the location on the front side, where the ribs 107 are not provided and to which the air flow is guided, such that the mist absorbing bodies 105 trap the mist M that is carried by the guided air flow.

Because the ribs 107 are provided in this manner on the bottom side of the base plate 101, along the outer edge portion of the optical disk 5, except for the location on the side toward the side wall 103 and the location on the front side, the air flow that is generated by the rotating of the optical disk 5 by the spindle motor 136 is guided to the locations where the ribs 107 are not provided. Furthermore, because the mist absorbing bodies 105 are provided in the locations to which the air flow is guided, the mist M that is carried by the guided air flow is absorbed by the mist absorbing bodies 105, making it possible to prevent the mist M from returning to the interior of the drive portion D1.

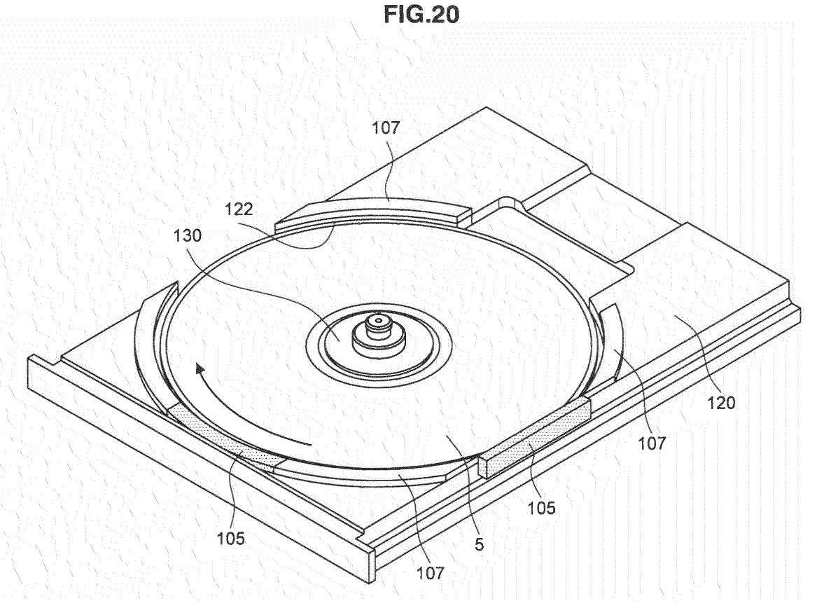

Next, yet another example of the air flow guide portion and the mist absorbing body in the present embodiment will be explained with reference to FIG. 20. FIG. 20 is an explanatory figure that shows yet another example of the air flow guide portion and the mist absorption body in the present embodiment, and it is an oblique view that shows an example in which the air flow guide portion and the mist absorbing body are provided in the tray 120 in a case where the optical disk device 100 is the tray type.

As shown in FIG. 20, this example is an example in which, in the case where the optical disk device 100 is the tray type, the mist absorbing bodies 105 and the ribs 107, as an example of the air flow guide portion, are provided in the tray 120. In this example, the ribs 107 and the mist absorbing bodies 105 are provided around the perimeter of the disk carrier portion 122 in which the optical disk 5 is carried on the tray 120. In this example as well, the print head 150 is provided in a position that is offset from the radial axis R, and the mist absorbing bodies 105 are provided in a location on the side toward the side wall 103 in the direction in which the print head 150 is offset (for example, in the vicinity of the cutout portion 122a of the disk carrier portion 122) and in a location on the front side (the front panel 114 side). As explained earlier, the mist M that is carried by the air flow that is generated by the rotation of the optical disk 5 collides with the side wall 103 and flows around to the underside of the optical disk 5 and the tray 120, diffusing along the side wall 103 toward the front side (the front panel 114 side) of the optical disk device 100. Therefore, in order to guide the air flow that contains the mist M to the outside of the drive portion D1, and in particular, in a direction that takes it away from the optical pick-up 140, the ribs 107 are provided on the tray 120, along the outer edge portion of the optical disk 5, and the mist absorbing bodies 105 are positioned in the location on the side toward the side wall 103 and in the location on the front side, where the ribs 107 are not provided and to which the air flow is guided, such that the mist absorbing bodies 105 trap the mist M that is carried by the guided air flow.

Because the ribs 107 are provided in this manner on the tray 120, along the outer edge portion of the optical disk 5, except for the location on the side toward the side wall 103 and the location on the front side, the air flow that is generated by the rotating of the optical disk 5 by the spindle motor 136 is guided to the locations where the ribs 107 are not provided. Furthermore, because the mist absorbing bodies 105 are provided in the locations to which the air flow is guided, the mist M that is carried by the guided air flow is absorbed by the mist absorbing bodies 105, making it possible to prevent the mist M from returning to the interior of the drive portion D1.

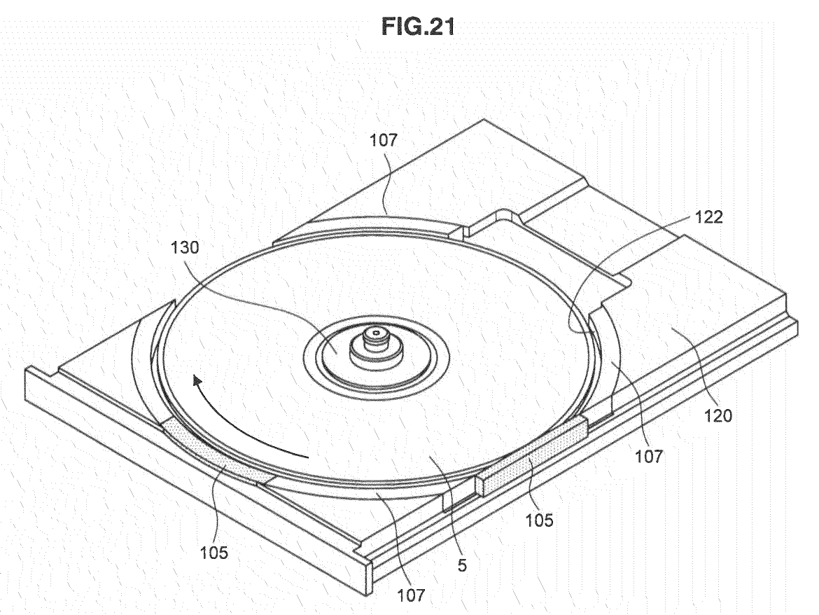

Next, yet another example of the air flow guide portion and the mist absorbing body in the present embodiment will be explained with reference to FIG. 21. FIG. 21 is an explanatory figure that shows yet another example of the air flow guide portion and the mist absorption body in the present embodiment, and it is an oblique view that shows an example in which the air flow guide portion and the mist absorbing body are provided in the tray 120 in a case where the optical disk device 100 is the tray type.

As shown in FIG. 21, this example is an example in which, in the same manner as in the example in FIG. 20, in the case where the optical disk device 100 is the tray type, the mist absorbing bodies 105 and the ribs 107, as an example of the air flow guide portion, are provided in the tray 120. In this example as well, the ribs 107 and the mist absorbing bodies 105 are provided around the perimeter of the disk carrier portion 122 in which the optical disk 5 is carried on the tray 120, but unlike the example in FIG. 20, the ribs 107 and the mist absorbing bodies 105 are fitted into the outer edge portion of the disk carrier portion 122. Note that with regard to other points, this example is the same as the example in FIG. 20, so a detailed explanation will be omitted.

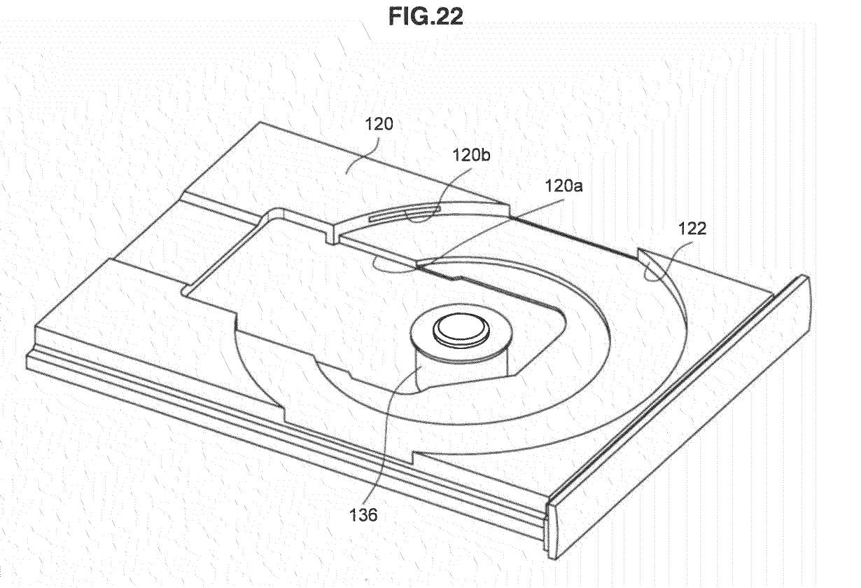

Next, yet another example of the air flow guide portion and the mist absorbing body in the present embodiment will be explained with reference to FIG. 22. FIG. 22 is an explanatory figure that shows yet another example of the air flow guide portion and the mist absorption body in the present embodiment, and it is an oblique view that shows an example in which the air flow guide portion and the mist absorbing body (not shown in the drawing) are provided in the tray 120 in a case where the optical disk device 100 is the tray type.

As shown in FIG. 22, this example is an example in which, in the case where the optical disk device 100 is the tray type, the mist absorbing body (not shown in the drawing) and an opening portion 120b, as an example of the air flow guide portion, are provided in the tray 120. In this example, as the air flow guide portion according to the present embodiment, the horizontal slit-shaped opening portion 120b is provided close to the outer edge portion of the optical disk 5, in a raised portion between the top surface of the tray 120 and the surface of the disk carrier portion 122 on which the optical disk 5 is carried on the tray 120. The mist absorbing body that is not shown in the drawing is installed on the air flow outlet side of the slit-shaped opening portion 120b (the back side of the tray 120).

Furthermore, in this example, it is desirable for the position where the opening portion 120b is provided to be on the downstream side of the position of the ink discharge portion 150a from which the ink droplets are discharged, in relation to the air flow that is generated along the outer edge portion of the optical disk 5 by the rotating of the optical disk 5 by the spindle motor 136. In particular, it is even more desirable for the opening portion 120b to be provided in the position that is closest to the ink discharge portion 150a (in a case where the optical disk 5 is rotating clockwise, the position that is shown in FIG. 22), where the concentration of the mist M that is carried by the air flow is thought to be at its greatest. Providing the opening portion 120b in this sort of position makes it possible to efficiently guide the air flow that contains the mist M to the outside of the drive portion D1, and in particular, in a direction that takes it away from the optical pick-up 140. Moreover, placing the mist absorbing body in a position to which the air flow is guided makes it possible to efficiently trap the mist M that is carried by the air flow that is guided by the opening portion 120b. Therefore, providing the opening portion 120b in this manner makes it possible to effectively inhibit the contamination of the drive portion D1 and the optical pick-up 140 in particular.

Optical Disk Device According to a Second Embodiment of the Present Invention

Next, an optical disk device according to a second embodiment of the present invention will be explained. A point that the optical disk device according to the second embodiment has in common with the first embodiment described above is that the air flow that is generated by the rotation of the optical disk 5 is guided to the outside of a drive portion, but the form of the air flow guide portion is different.

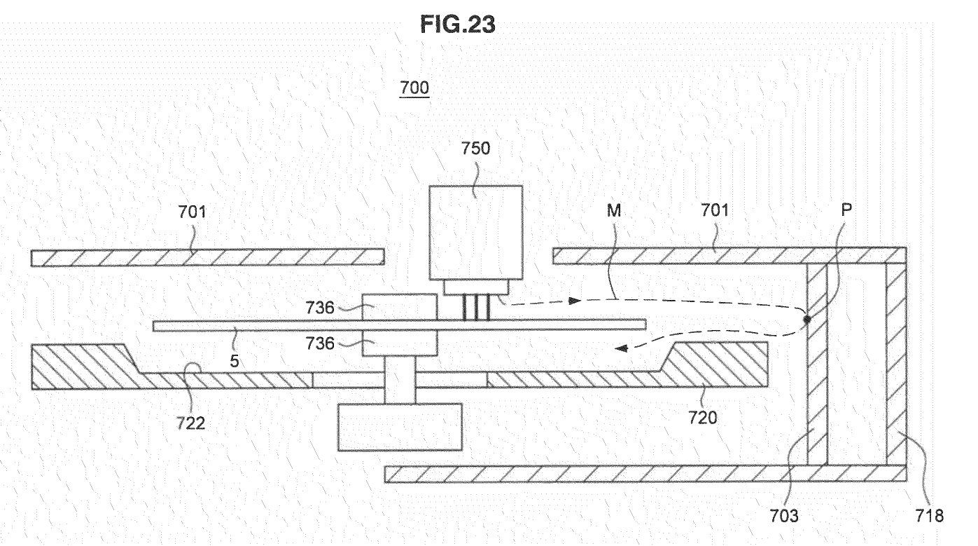

First, before the optical disk device according to the present embodiment is explained, the flow of the mist M in the known optical disk device 700 described earlier, which serves as a premise for the present embodiment, will be explained with reference to FIG. 23. FIG. 23 is an explanatory figure that shows the flow of the mist M within the drive portion D7 of the known optical disk device 700 as seen from the front panel 714 side.

As shown in FIG. 23, in the known optical disk device 700, the mist M of the ink droplets that are discharged from the print head 750 is carried by the steady air flow that is generated by the rotating of the optical disk 5 by a spindle 736 and floats within the drive portion D7 that is surrounded by a base plate 701 on which the print head 750 and the like are provided and a side wall 703. In the process, the mist M that is generated from the print head 750 is carried by the steady air flow, floats around the outer edge portion of the optical disk 5, and collides with the side wall 703 at a point P. The mist M that has collided with the side wall 703 flows around to at least one of the underside (the recording surface side) of the optical disk 5 and the underside of the tray 720 on which the optical disk 5 is carried, where it contaminates the component parts (for example, the optical pick-up 740 and the like) in the interior of the drive portion D7. At this time, if the mist M contaminates the optical pick-up 740, a problem occurs in that the amount of light that is reflected from the optical disk 5 decreases, in the worst case creating a state in which the recording and playback operations cannot be performed.

Methods that have been proposed to deal with this problem in an ordinary ink jet printer that prints in the X and Y directions include, for example, a method that utilizes an air flow that is generated by the movement of a head, as in Japanese Patent Application Publication No. JP-A-2007-185835, and a method that uses a fan that is provided within the printer to suck up the mist M, as in Japanese Patent Application Publication No. JP-A-2000-211163.

However, in a case where printing is performed on the recording surface (the label surface) of a disk-shaped recording medium such as an optical disk or the like, the disk-shaped recording medium is rotating at a high speed, and because a steady flow of air is generated by the rotation, the methods described above that are used in the ink jet printer cannot be expected to have any effect of inhibiting the contamination of the component parts within the drive portion D7 by the mist M.

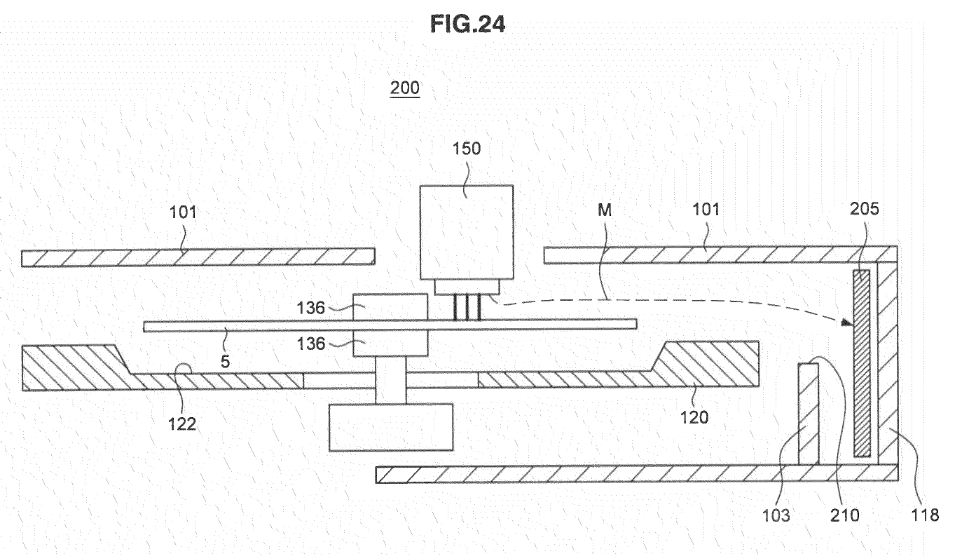

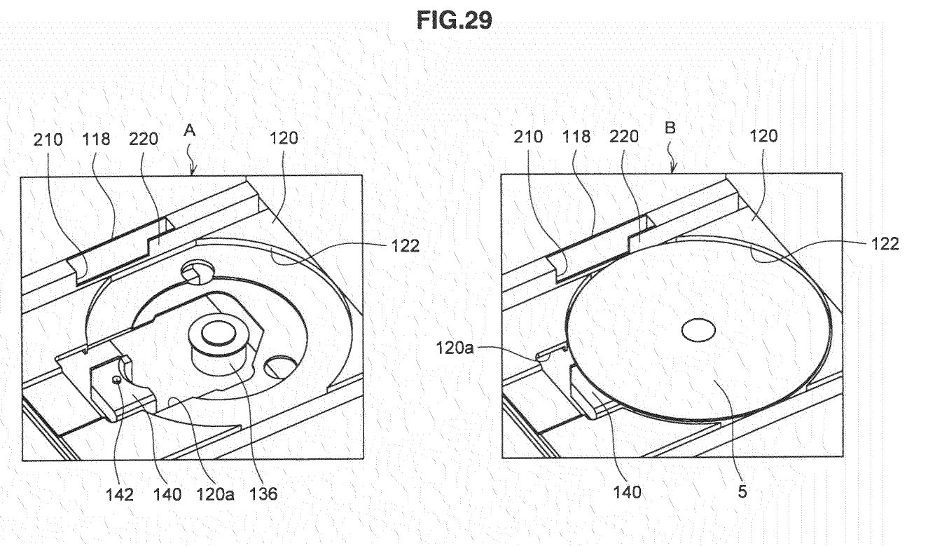

Accordingly, in an optical disk device 200 according to the present embodiment, as shown in FIGS. 24 and 29, a gap is opened up between the bottom face of the base plate 101 and a top edge of the side wall 103 close to the outer edge portion of the optical disk 5, thus providing an air flow passage 210 for the air flow that is generated by the rotation of the optical disk 5. The air flow passage 210 is provided such that it passes through the side wall 103 and makes the drive portion D1 continuous with an area between the side wall 103 and the housing 110, fulfilling the function of the air flow guide portion according to the present embodiment. In FIG. 29 shows a modified example of the present embodiment, in which a barrier wall 220 is provided to prevent the air flow that passes through the air flow passage 210, collides with the side panel 118 (in a case where a mist absorbing body 205 that will be described later is provided, collides with the mist absorbing body 205), and then rebounds from returning to the interior of the drive portion D1. The configuration of the barrier wall 220 will be described later.

Note that FIG. 24 is an explanatory figure that shows the flow of the mist M within the drive portion D1 of the optical disk device 200 according to the present embodiment as seen from the front panel side. Furthermore, FIG. 29 is an oblique view that shows an example of a configuration of the air flow passage 210 and the barrier wall 220 according to the present embodiment, with A indicating a state before the optical disk 5 is mounted and B indicating a state after the optical disk 5 is mounted.

The air flow that is generated by the rotating of the optical disk 5 by the spindle motor 136 passes through the air flow passage 210 and reaches an area between the side wall 103 of the drive portion D1 and the side panel 118 of the optical disk device 200 (hereinafter called the ink trap area). Providing the air flow passage 210 on the side face of the drive portion D1 thus makes it possible to inhibit the rebounding of the air flow that contains the mist M after it collides with the side wall 103 and to inhibit the flowing of the mist M around to the underside (the recording surface side) of the optical disk 5 and the underside of the tray 120, both of which occur in the known optical disk device 700. Therefore, according to the present embodiment, it is possible to inhibit the contamination of the component parts in the interior of the drive portion D1 (for example, the optical pick-up 140 (refer to FIG. 29 and the like), the tray 120, and the like). Note that the optimum size and position of air flow passage 210 can be determined based on the revolution speed of the optical disk 5, the shape of the tray 120, and the like.

In addition, in the optical disk device 200 according to the present embodiment, because the mist absorbing body 205 is located within the ink trap area, as shown in FIG. 24, the mist M that is carried by the air flow is absorbed by the mist absorbing body 205. Therefore, providing the mist absorbing body 205 makes it possible to trap the mist M that is carried by the air flow that is guided to the outside of the drive portion D1 and to enhance the effect of inhibiting the contamination of the component parts such as the optical pick-up 140, the tray 120, and the like in the interior of the drive portion D1.

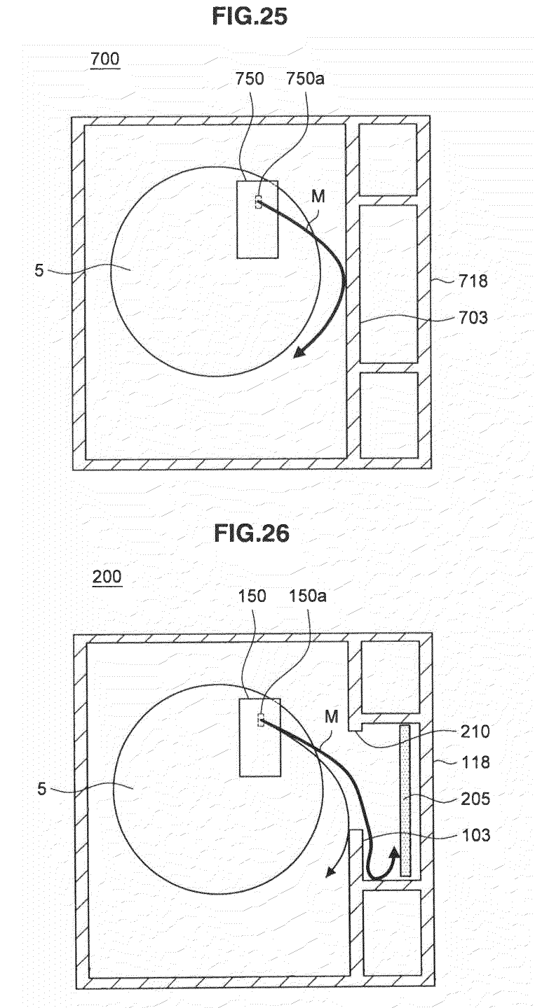

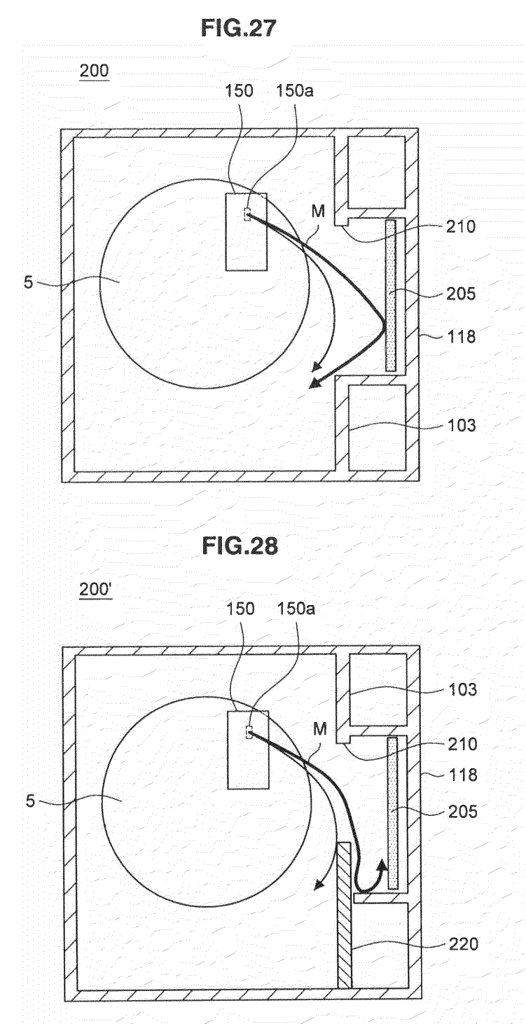

Next, a comparison of the flow of the mist M in the known optical disk device 700, in the optical disk device 200 according to the present embodiment, and in a optical disk device 200′ according to a modified example of the present embodiment will be explained with reference to FIGS. 25 to 28. Note that FIG. 25 is an explanatory figure that shows the flow of the mist M within the drive portion D7 of the known optical disk device 700 as seen from the top side. FIGS. 26 and 27 are explanatory figures that show the flow of the mist M within the drive portion D1 of the optical disk device 200 according to the present embodiment as seen from the top side. FIG. 28 is an explanatory figure that shows the flow of the mist M within the drive portion D1 of the optical disk device 200′ according to the modified example of the present embodiment as seen from the top side.

In the known optical disk device 700, as shown in FIG. 25, the air flow that contains the mist M of the ink droplets that are discharged from the ink discharge portion 750a of the print head 750 collides with the side wall 703 of the drive portion D7 in the same manner as in the case that is shown in FIG. 23. The air flow that has collided with the side wall 703 then rebounds, and the mist M flows around to the underside of the optical disk 5.

On the other hand, as shown in FIG. 26, providing the air flow passage 210 by opening up the gap between the bottom face of the base plate 101 and the top edge of the side wall 103 close to the outer edge portion of the optical disk 5 makes it possible to drift to the outside of the drive portion D1 the mist M that is carried by the air flow that is generated by the rotation of the optical disk 5 and to inhibit the mist M from flowing around to the underside of the optical disk 5. Also at this time, because the mist absorbing body 205 is installed in the area (the ink trap area) between the side wall 103 of the drive portion D1 and the side panel 118 of the optical disk device 200, the mist M that is contained in the air flow that is guided from within the drive portion D1 by the air flow passage 210 is absorbed by the mist absorbing body 205.

However, as shown in FIG. 27, if only the air flow passage 210 is provided, there are cases in which the mist M that is contained in the air flow that rebounds of the mist absorbing body 205 (off the side panel 118 in a case where the mist absorbing body 205 is not provided) once again drifts into the drive portion D1 and flows around to the underside of the optical disk 5. The mist M that flows around to the underside of the optical disk 5 thus contaminates the component parts such as the optical pick-up 140, the tray 120, and the like.

Accordingly, in the optical disk device 200′ according to the modified example of the present embodiment, as shown in FIG. 28, the barrier wall 220 is provided in a part of an inlet portion of the air flow passage 210 (a boundary portion between the drive portion D1 and the ink trap area) to prevent the air flow that has rebounded off of one of the mist absorbing body 205 and the side panel 118 from returning to the interior of the drive portion D1. Because the barrier wall 220 is provided in this manner, the air flow that has rebounded off of one of the mist absorbing body 205 and the side panel 118 collides with the barrier wall 220 and is turned back into the ink trap area. Therefore, the mist M that is contained in the air flow accumulates within the ink trap area and can be prevented from drifting once again into the drive portion D1 and flowing around to the underside of the optical disk 5. Note that in a case where the mist absorbing body 205 is installed within the ink trap area, providing the barrier wall 220 makes it possible to enhance even more the effect of absorbing (trapping) the mist M.

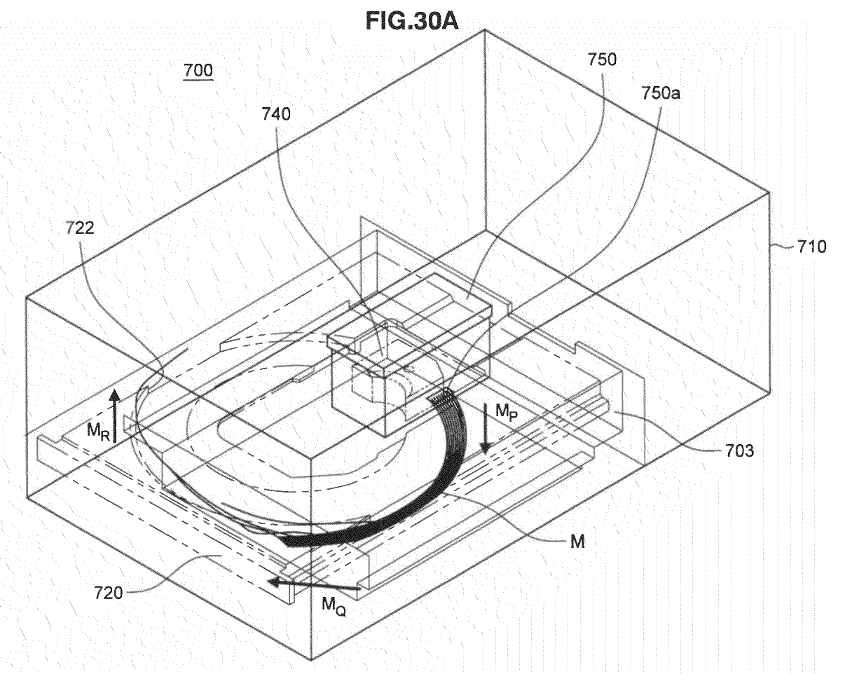

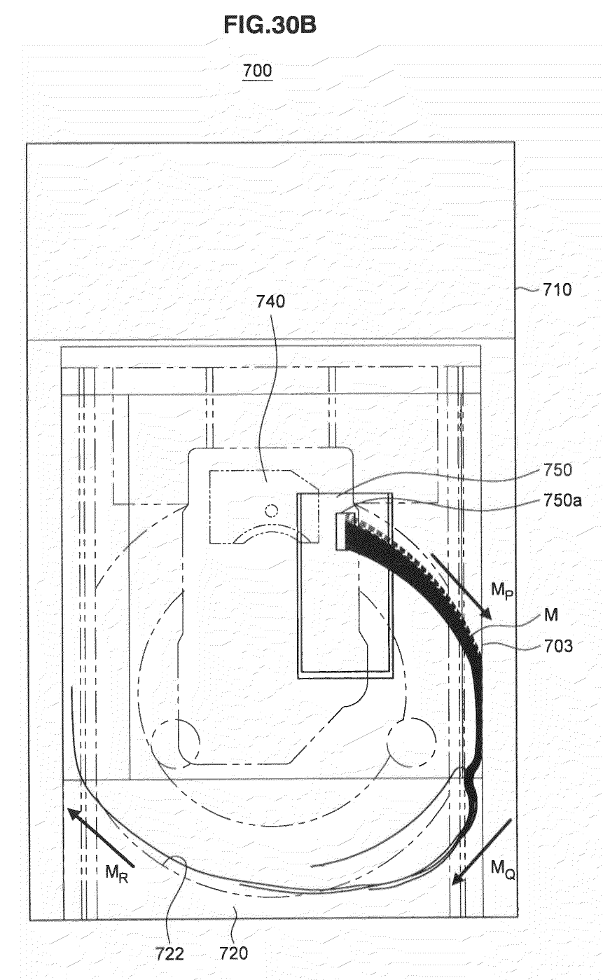

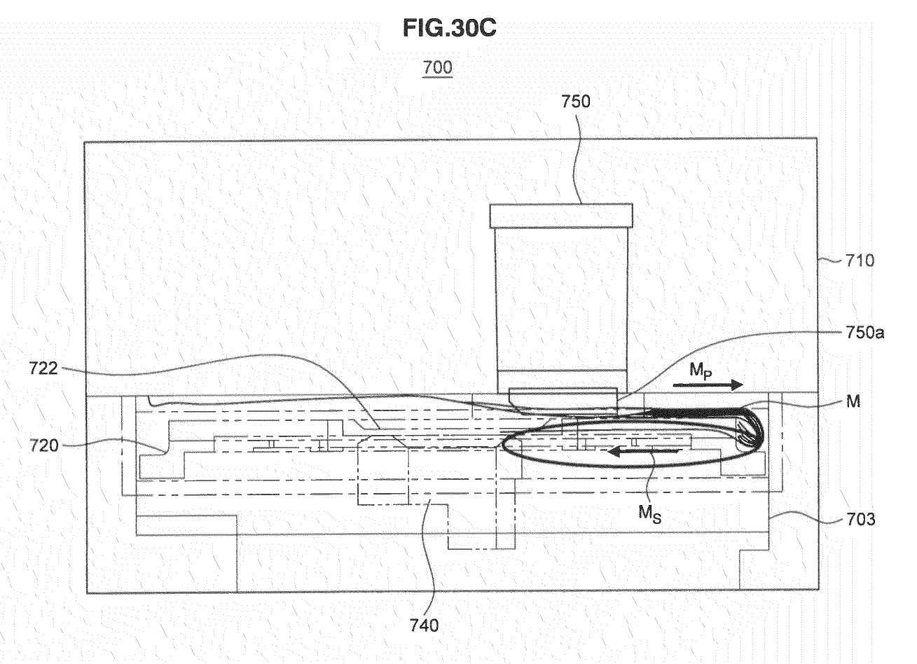

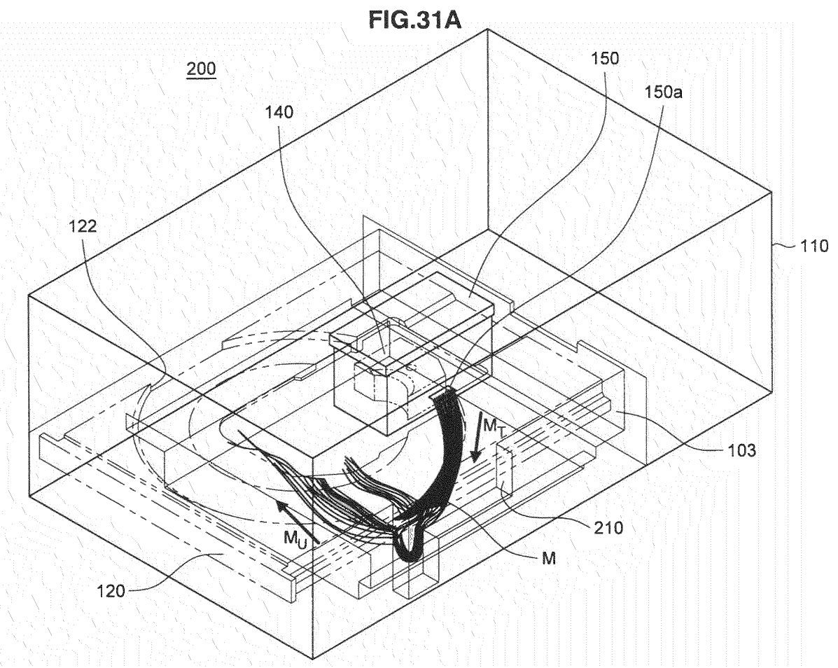

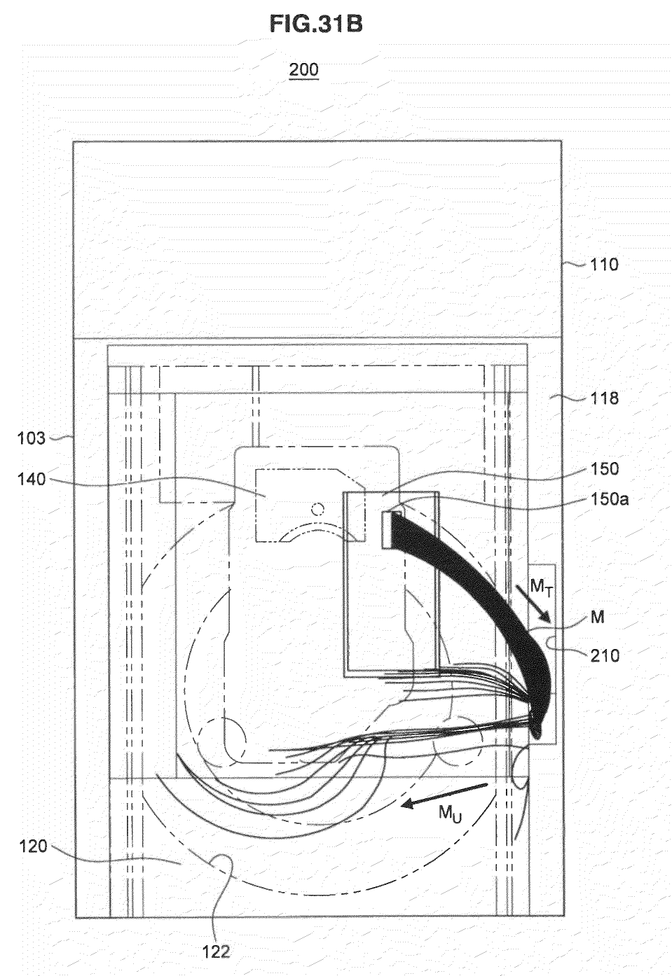

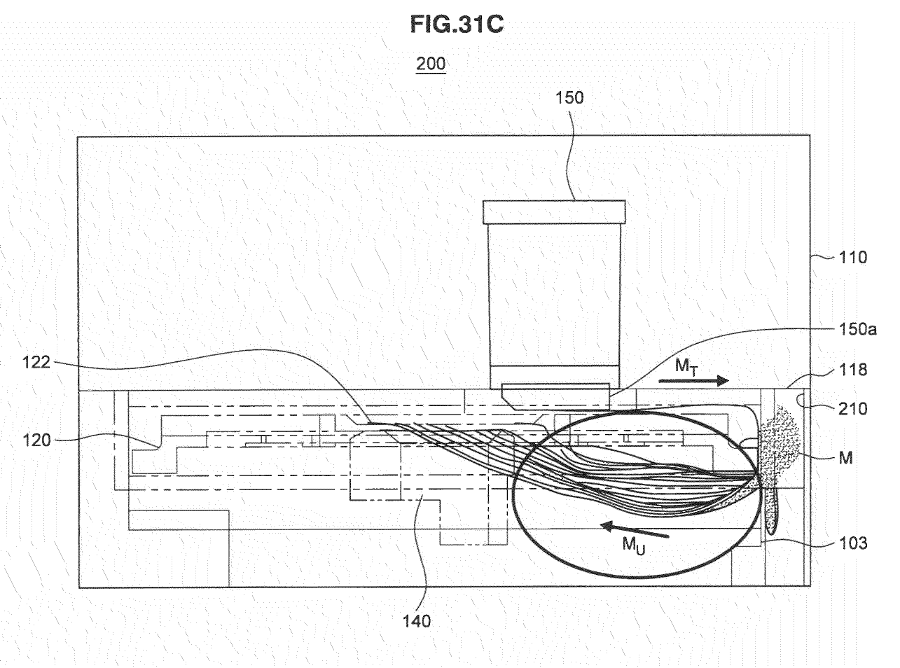

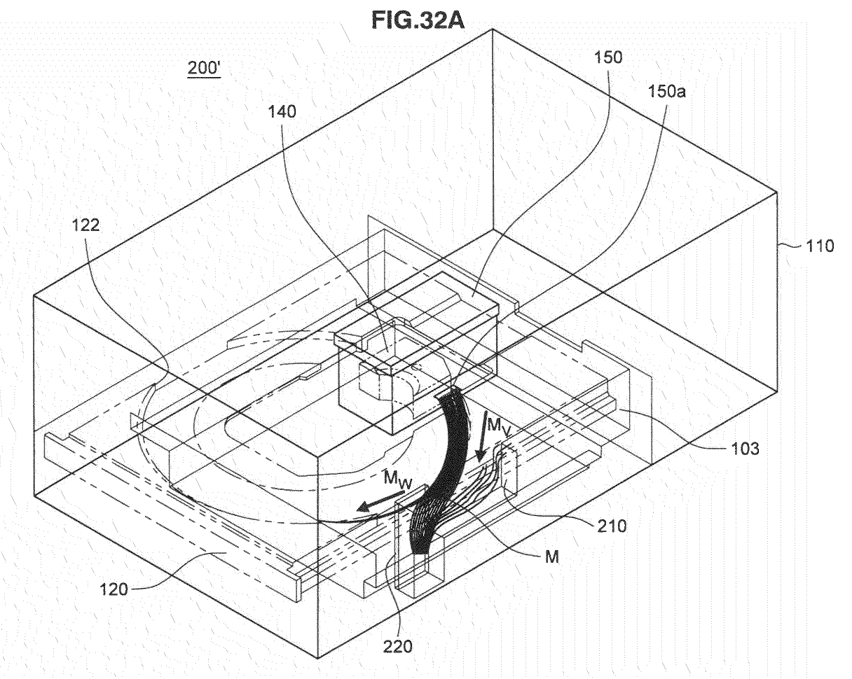

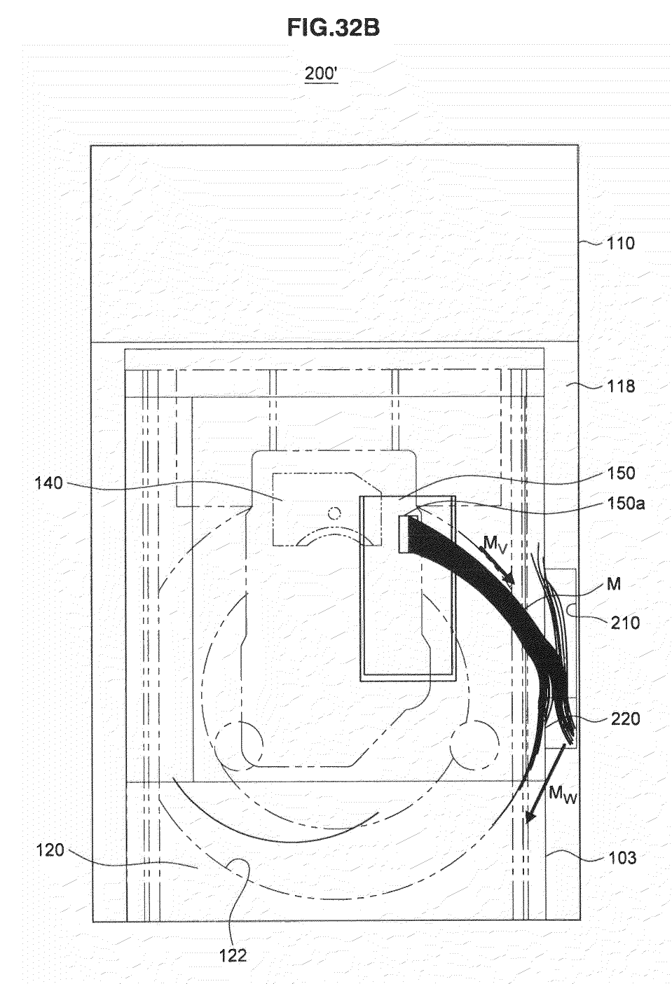

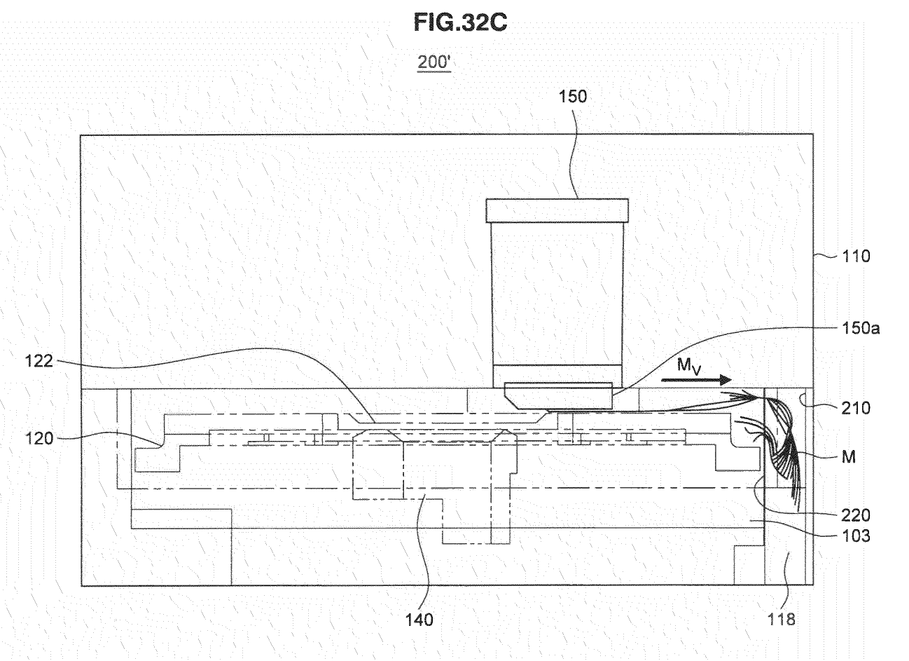

Next, results of simulations that were conducted by the inventors of the present invention will be explained with reference to FIGS. 30A to 30C, 31A to 31C, and 32A to 32C. Note that FIGS. 30A to 30C are explanatory figures that show the results of a simulation of the drifting of the mist in the known optical disk device 700 and are an oblique view, a plan view, and a front view, respectively. FIGS. 31A to 31C are explanatory figures that show the results of a simulation of the drifting of the mist in the optical disk device 200 according to the present embodiment and are an oblique view, a plan view, and a front view, respectively. FIGS. 32A to 32C are explanatory figures that show the results of a simulation of the drifting of the mist in the optical disk device 200′ according to the modified example of the present embodiment and are an oblique view, a plan view, and a front view, respectively.

The simulations were conducted for the known optical disk device 700 (without an air flow passage and a barrier wall), the optical disk device 200 according to the present embodiment (with the air flow passage 210 and without a barrier wall), and the optical disk device 200′ according to the modified example of the present embodiment (with the air flow passage 210 and the barrier wall 220), and each of the simulations was conducted on the assumption that the revolution speed of the optical disk 5 was 1200 rpm.

First, in the known optical disk device 700, as shown in FIGS. 30A and 30B, the mist M of the ink droplets that are discharged from the ink discharge portion 750a of the print head 750 is carried around the outer edge portion of the optical disk 5 by the steady air flow that is generated by the rotation of the optical disk 5 and first drifts toward the side wall 703 of the drive portion D7, as indicated by an arrow M_{P}. Thereafter, a portion of the mist M that has collided with the side wall 703 drifts along the side wall 703 and, as indicated by an arrow M_{Q}, drifts along the outer edge of the optical disk 5 toward the front panel 714 side of the optical disk device 700. The mist M also drifts along the outer edge of the optical disk 5 toward the rear panel 716 side of the optical disk device 700, as indicated by an arrow M_{R}, and diffuses within the housing 710. As shown in FIG. 30C, a portion of the mist M that has collided with the side wall 703 on the path that is indicated by the arrow M_{P} rebounds from the side wall 703 and flows around to the underside of the optical disk 5 and the underside of the tray 720, as indicated by an arrow M_{S}, and diffuses once again within the drive portion D7 (refer to the circled area in FIG. 30C). The optical pick-up 740, the tray 720, and the like are therefore contaminated by the mist M that has flowed around to the underside of the optical disk 5 and the underside of the tray 720 in this manner.

Next, in the optical disk device 200 according to the present embodiment, as shown in FIGS. 31A and 31B, the mist M of the ink droplets that are discharged from the ink discharge portion 150a of the print head 150 is carried around the outer edge portion of the optical disk 5 by the steady air flow that is generated by the rotation of the optical disk 5 and first drifts toward the side wall 103 of the drive portion D1, as indicated by an arrow M_{T}. Here, in the optical disk device 200 according to the present embodiment, the air flow passage 210 is provided in the upper portion of the side wall 103 on the near side, with which the air flow that drifts toward the side wall 103 collides, so after passing through the air flow passage 210, the air flow enters the ink trap area between the side wall 103 and the side panel 118 of the housing 110.

Thereafter, as shown in FIG. 31C, a portion of the air flow that contains the mist M remains in the ink trap area, but another portion rebounds after colliding with the side panel 118, flows around to the underside of the optical disk 5 and the underside of the tray 120, as indicated by an arrow M_{U} in FIGS. 31A to 31C, and diffuses once gain within the drive portion D1 (refer to the circled area in FIG. 31C). The optical pick-up 140, the tray 120, and the like are therefore contaminated by the mist M that has flowed around to the underside of the optical disk 5 and the underside of the tray 120 in this manner. In other words, in a case where only the air flow passage 210 is provided and the barrier wall 220 is not provided, although the effect of inhibiting the contamination of the optical pick-up 140 and the like by the mist M is achieved to some extent, a portion of the mist M that enters the ink trap area diffuses once gain within the drive portion D1 in some cases.

In contrast, in the optical disk device 200′ according to the modified example of the present embodiment, as shown in FIGS. 32A to 31C, the mist M of the ink droplets that are discharged from the ink discharge portion 150a of the print head 150 is carried around the outer edge portion of the optical disk 5 by the steady air flow that is generated by the rotation of the optical disk 5 and first drifts toward the side wall 103 of the drive portion D1, as indicated by an arrow M_{V}. Here, in the optical disk device 200′ according to the modified example of the present embodiment, the air flow passage 210 is provided in the upper portion of the side wall 103 on the near side, with which the air flow that drifts toward the side wall 103 collides, so after passing through the air flow passage 210, the air flow enters the ink trap area between the side wall 103 and the side panel 118 of the housing 110.

Thereafter, as shown in FIG. 32C, a portion of the air flow that contains the mist M remains in the ink trap area, while another portion starts to rebound after colliding with the side panel 118, but in the present modified example, the barrier wall 220 is provided in the inlet portion of the air flow passage 210, so the drifting of the mist M into the drive portion D1 is blocked by the barrier wall 220. This means that, according to the modified example, it is possible to inhibit the mist M from flowing around to the underside of the optical disk 5 and the underside of the tray 120 and diffusing once again within the drive portion D1. Therefore, according to the modified example, the effect of inhibiting the contamination of the component parts within the drive portion D1, such as the optical pick-up 140, the tray 120, and the like, can be enhanced.

Note that according to this simulation, in some cases a very small portion of the mist M that is trapped in the ink trap area is carried by the steady air flow around the outer edge portion of the optical disk 5, as shown by an arrow M_{W} in FIGS. 32A and 32B, but the amount of this portion of the mist M is extremely low, and almost none of it flows around to the underside of the optical disk 5 and the underside of the tray 120, so the modified example is thought to enhance very strongly the effect of inhibiting the contamination of the component parts within the drive portion D1, such as the optical pick-up 140, the tray 120, and the like.

For the optical disk device 200′ according to the modified example described above, the inventors also conducted simulations in which the revolution speed of the optical disk 5 was 900 rpm and 1800 rpm.

The results of the simulation in which the revolution speed of the optical disk 5 was 900 rpm, a low revolution speed, were that the speed of the air flow that is generated by the rotation of the optical disk 5 is slower, such that the air flow is more likely to flow along the outer edge portion of the optical disk 5 than it is when the revolution speed is 1200 rpm. This means that a larger amount of the mist M drifts toward the front panel 114 side (the far side from the print head 150) of the optical disk device 200′. In contrast, when the revolution speed of the optical disk 5 is 1800 rpm, a high revolution speed, the speed of the air flow that is generated by the rotation of the optical disk 5 is faster, so the air flow is more likely to move toward the rear panel 116 side of the optical disk device 200′ than when the revolution speed is 1200 rpm. This means that a larger amount of the mist M drifts toward the rear panel 116 that is on the near side of the print head 150 of the optical disk device 200′.

Because the direction of the air flow that is generated by the rotation of the optical disk 5 varies in this way according to the differences in the revolution speed, the position where the mist M collides with the side wall 103 also varies. It is therefore desirable to adjust the position where the air flow passage 210 is provided according to the revolution speed of the optical disk 5. Specifically, because the flow becomes more likely to move toward the front panel 114 side of the optical disk device 200′ as the revolution speed of the optical disk 5 becomes slower, providing the air flow passage 210 in a position that is farther from the print head 150 as the revolution speed of the optical disk 5 becomes slower makes it possible to inhibit more effectively the contamination of the component parts in the interior of the drive portion D1.

The present application contains subject matter related to that disclosed in Japanese Priority Patent Application JP 2008-134712 filed in the Japan Patent Office on May 22, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

For example, the embodiments described above were explained using an example of an ink jet print head as the print head 150, but another type of print head may also be used as the print head 150 according to the present invention.

In addition, members such as the cap, the ink sump, and the like may also have different shapes from those of the cap 192, the ink sump 194, and the like according to the embodiments described above.

What is claimed is:

1. An disk recording device, comprising:
a disk rotation mechanism on which a disk-shaped recording medium is removably mounted and that rotates the mounted disk-shaped recording medium;
a pick-up device that is disposed such that it faces a recording surface of the disk-shaped recording medium that is mounted on the disk rotation mechanism, and that at least one of records information to and plays back information from the disk-shaped recording medium;
a print head that is movably disposed on a printing surface side of the disk-shaped recording medium that is mounted on the disk rotation mechanism, the printing surface being on an opposite side from the recording surface, and that has an ink discharge portion that discharges an ink droplet in the direction of the printing surface of the rotating disk-shaped recording medium; and
an air flow guide portion that is provided around the disk-shaped recording medium that is mounted on the disk rotation mechanism, and that guides an air flow that is generated by the rotating of the disk-shaped recording medium by the disk rotation mechanism.

2. The disk recording device according to claim 1,
wherein the air flow guide portion guides the air flow that is generated by the rotating of the disk-shaped recording medium in a direction that takes it away from the pick-up device.

3. The disk recording device according to claim 2, further comprising:
a base plate that partitions an interior portion of the disk recording device into an information recording area that is an area on the recording surface side of the disk-shaped recording medium that is mounted on the disk rotation mechanism, and in which the disk rotation mechanism and the pick-up device are disposed, and a printing area that is an area on the printing surface side of the disk-shaped recording medium that is mounted on the disk rotation mechanism, and in which the print head is disposed, the print head being installed on the base plate,
wherein the air flow guide portion is at least one opening portion that is provided on the base plate.

4. The disk recording device according to claim 3,
wherein the opening portion is disposed on the printing surface side of the disk-shaped recording medium that is mounted on the disk rotation mechanism.

5. The disk recording device according to claim 4,
wherein the opening portion is provided in the vicinity of an outer edge portion of the disk-shaped recording medium that is mounted on the disk rotation mechanism.

6. The disk recording device according to claim 5,
wherein the opening portion is provided downstream, in relation to the direction of the rotation of the disk-shaped recording medium, from the position of the ink discharge portion in a case where the print head is printing on the outer edge portion of the disk-shaped recording medium.

7. The disk recording device according to claim 6, further comprising:
a mist absorbing body that absorbs a mist that is carried by the air flow, the mist absorbing body being provided downstream from the air flow guide portion, in relation to the air flow that is guided by the air flow guide portion.

8. The disk recording device according to claim 7, further comprising:
a housing that encloses the disk recording device; and
a side wall that encloses a side face of the information recording area,
wherein the mist absorbing body is disposed between the side wall and the housing.

9. The disk recording device according to claim 2,
wherein an interior portion of the disk recording device is partitioned into an information recording area that is an area on the recording surface side of the disk-shaped recording medium that is mounted on the disk rotation mechanism, and in which the disk rotation mechanism and the pick-up device are disposed, and a printing area that is an area on the printing surface side of the disk-shaped recording medium that is mounted on the disk rotation mechanism, and in which the print head is disposed,
the disk recording device further comprising a side wall that encloses a side face of the information recording area,
wherein the air flow guide portion is at least one opening portion that is provided in the side wall.

10. The disk recording device according to claim 9, further comprising:
a disk tray that loads and unloads the disk-shaped recording medium into and out of the information recording area and has a disk carrier portion on which the disk-shaped recording medium is carried,
wherein a cutout portion is provided in a side face of the disk carrier portion, and
the at least one opening portion is provided in the vicinity of the cutout portion.

11. The disk recording device according to claim 10, further comprising:
a mist absorbing body that absorbs a mist that is carried by the air flow, the mist absorbing body being provided downstream from the air flow guide portion, in relation to the air flow that is guided by the air flow guide portion.

12. The disk recording device according to claim 11, further comprising:
a housing that encloses the disk recording device,
wherein the mist absorbing body is provided between the side wall and the housing.

13. The disk recording device according to claim 3,
wherein the air flow guide portion is a rib, a portion of which is non-continuous, that is provided under the base plate in the vicinity of an outer edge portion of the disk-shaped recording medium that is mounted on the disk rotation mechanism,
the disk recording device further comprising a mist absorbing body that absorbs a mist that is carried by the air flow that is guided by the air flow guide portion, the mist absorbing body being provided such that it fills the non-continuous portion of the air flow guide portion.

14. The disk recording device according to claim 3, further comprising:
a disk tray that loads and unloads the disk-shaped recording medium into and out of the information recording area and has a disk carrier portion on which the disk-shaped recording medium is carried,
wherein the air flow guide portion is a rib, a portion of which is non-continuous, that is provided such that it surrounds an outer edge portion of the disk carrier portion,
the disk recording device further comprising a mist absorbing body that absorbs a mist that is carried by the air flow that is guided by the air flow guide portion, the mist absorbing body being provided such that it fills the non-continuous portion of the air flow guide portion.

15. The disk recording device according to claim 3, further comprising:
a disk tray that loads and unloads the disk-shaped recording medium into and out of the information recording area and has a disk carrier portion on which the disk-shaped recording medium is carried,
wherein the air flow guide portion is an opening portion that is provided in the vicinity of an outer edge portion of the disk-shaped recording medium, in a raised portion between a top face of the disk tray and the surface of the disk carrier portion on which the disk-shaped recording medium is carried.

16. The disk recording device according to claim 2,
wherein an interior portion of the disk recording device is partitioned into an information recording area that is an area on the recording surface side of the disk-shaped recording medium that is mounted on the disk rotation mechanism, and in which the disk rotation mechanism and the pick-up device are disposed, and a printing area that is an area on the printing surface side of the disk-shaped recording medium that is mounted on the disk rotation mechanism, and in which the print head is disposed,
the disk recording device further comprising a housing that encloses the disk recording device; and
a side wall that encloses a side face of the information recording area,
wherein the air flow guide portion is an air flow passage, for the air flow, that is provided such that it passes through the side wall and renders the information recording area continuous with an area between the side wall and the housing.

17. The disk recording device according to claim 16, further comprising:
a barrier wall that is disposed in a portion of the air flow passage and that prevents the air flow that rebounds after colliding with the housing from returning to the information recording area.

18. The disk recording device according to claim 16, further comprising:
a mist absorbing body that absorbs a mist that is carried by the air flow that is guided by the air flow guide portion, the mist absorbing body being provided in the area between the side wall and the housing.

19. The disk recording device according to claim 16,
wherein a position where the air flow passage is installed is determined according to a speed at which the disk-shaped recording medium is rotated by the disk rotation mechanism. x
